(19) United States
(12) Patent Application Publication
(10) Pub. No.: US 2026/0289898 A1
(43) Pub. Date: Sep. 24, 2026

(54) GAUSSIAN SPLATTING RAY TRACING

(71) Applicant: QUALCOMM Incorporated, San Diego, CA (US)

(72) Inventors: Alex LIU, San Diego, CA (US); Nikolaos GEORGIS, San Diego, CA (US); Lei MA, San Diego, CA (US)

(21) Appl. No.: 19/088,771

(22) Filed: Mar. 24, 2025

(51) Int. Cl. G06T 15/06

(52) U.S. Cl. CPC G06T 15/06

(57) ABSTRACT

This disclosure provides systems, devices, apparatus, and methods, including computer programs encoded on storage media, for Gaussian splatting ray tracing for photo-realistic simulations. A graphics processor may generate a simulated image frame based on an input image frame and a first set of GS parameters associated with a GS training model and a first ray tracing operation. The graphics processor may determine a second set of GS parameters based on the simulated image frame and a loss function. The graphics processor may generate an optimized simulated image frame based on the simulated image frame, the second set of GS parameters, and a second ray tracing operation. The graphics processor may output the optimized simulated image frame.

### TECHNICAL FIELD

The present disclosure relates generally to processing systems and techniques for graphics processing.

### INTRODUCTION

Computing devices often perform graphics and/or display processing (e.g., utilizing a graphics processing unit (GPU), a central processing unit (CPU), a display processor, etc.) to render and display visual content. Such computing devices may include, for example, computer workstations, mobile phones such as smartphones, embedded systems, personal computers, tablet computers, and video game consoles. GPUs are configured to execute a graphics processing pipeline that includes one or more processing stages, which operate together to execute graphics processing commands and output a frame. A central processing unit (CPU) may control the operation of the GPU by issuing one or more graphics processing commands to the GPU. Modern day CPUs are typically capable of executing multiple applications concurrently, each of which may need to utilize the GPU during execution. A display processor may be configured to convert digital information received from a CPU to analog values and may issue commands to a display panel for displaying the visual content. A device that provides content for visual presentation on a display may utilize a CPU, a GPU, and/or a display processor.

Current techniques for graphics processing may utilize Gaussian splatting (GS), such as three-dimensional (3D) GS, to represent images, by directly rendering volume data without converting the data into surface or line primitives. However, the current techniques may not address issues with photo-realistic quality associated with GS techniques, as well as issues with quality, latency, and processing utilization. There is a need for improved GS image representation techniques.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus includes a memory; and a processor coupled to the memory and, based on information stored in the memory, the processor is configured to: generate a simulated image frame based on an input image frame and a first set of (GS) parameters associated with a GS training model and a first ray tracing operation; determine a second set of GS parameters based on the simulated image frame and a loss function; generate an optimized simulated image frame based on the simulated image frame, the second set of GS parameters, and a second ray tracing operation; and output the optimized simulated image frame.

To the accomplishment of the foregoing and related ends, the one or more aspects include the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a block diagram that illustrates an example content generation system in accordance with one or more techniques of this disclosure.

FIG. 2 illustrates an example graphics processor (e.g., a graphics processing unit (GPU)) in accordance with one or more techniques of this disclosure.

FIG. 3 illustrates an example image or surface in accordance with one or more techniques of this disclosure.

FIG. 4 illustrates an example display framework including a display processor and a display in accordance with one or more techniques of this disclosure.

FIG. 5 illustrates a diagram for examples of GS image representation in accordance with one or more techniques of this disclosure.

FIG. 6 illustrates a diagram of a system flow for GS ray tracing for photo-realistic simulations in accordance with one or more techniques of this disclosure.

FIG. 7 illustrates a diagram of example optimizations for GS ray tracing for photo-realistic simulations in accordance with one or more techniques of this disclosure.

FIG. 8 illustrates a diagram of an example optimization for GS ray tracing for photo-realistic simulations in accordance with one or more techniques of this disclosure.

FIG. 9 illustrates a diagram of ray tracing GS training for photo-realistic simulations in accordance with one or more techniques of this disclosure.

FIG. 10 is a call flow diagram illustrating example communications between a graphics processor and a display processor in accordance with one or more techniques of this disclosure.

FIG. 11 is a flowchart of an example method of graphics processing in accordance with one or more techniques of this disclosure.

FIG. 12 is a flowchart of an example method of graphics processing in accordance with one or more techniques of this disclosure.

### DETAILED DESCRIPTION

Various aspects of systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of this disclosure to those skilled in the art. Based on the teachings herein one skilled in the art should appreciate that the scope of this disclosure is intended to cover any aspect of the systems, apparatuses, computer program products, and methods disclosed herein, whether implemented independently of, or combined with, other aspects of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. Any aspect disclosed herein may be embodied by one or more elements of a claim.

Although various aspects are described herein, many variations and permutations of these aspects fall within the scope of this disclosure. Although some potential benefits and advantages of aspects of this disclosure are mentioned, the scope of this disclosure is not intended to be limited to particular benefits, uses, or objectives. Rather, aspects of this disclosure are intended to be broadly applicable to different wireless technologies, system configurations, processing systems, networks, and transmission protocols, some of which are illustrated by way of example in the figures and in the following description. The detailed description and drawings are merely illustrative of this disclosure rather than limiting, the scope of this disclosure being defined by the appended claims and equivalents thereof.

Several aspects are presented with reference to various apparatus and methods. These apparatus and methods are described in the following detailed description and illustrated in the accompanying drawings by various blocks, components, circuits, processes, algorithms, and the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors (which may also be referred to as processing units). Examples of processors include microprocessors, microcontrollers, graphics processing units (GPUs), general purpose GPUs (GPGPUs), central processing units (CPUs), application processors, digital signal processors (DSPs), reduced instruction set computing (RISC) processors, systems-on-chip (SOCs), baseband processors, application specific integrated circuits (ASICs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software can be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

The term application may refer to software. As described herein, one or more techniques may refer to an application (e.g., software) being configured to perform one or more functions. In such examples, the application may be stored in a memory (e.g., on-chip memory of a processor, system memory, or any other memory). Hardware described herein, such as a processor may be configured to execute the application. For example, the application may be described as including code that, when executed by the hardware, causes the hardware to perform one or more techniques described herein. As an example, the hardware may access the code from a memory and execute the code accessed from the memory to perform one or more techniques described herein. In some examples, components are identified in this disclosure. In such examples, the components may be hardware, software, or a combination thereof. The components may be separate components or sub-components of a single component.

In one or more examples described herein, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can include a random access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

As used herein, instances of the term “content” may refer to “graphical content,” an “image,” etc., regardless of whether the terms are used as an adjective, noun, or other parts of speech. In some examples, the term “graphical content,” as used herein, may refer to a content produced by one or more processes of a graphics processing pipeline. In further examples, the term “graphical content,” as used herein, may refer to a content produced by a processing unit configured to perform graphics processing. In still further examples, as used herein, the term “graphical content” may refer to a content produced by a graphics processing unit. As used herein, instances of the terms “Gaussian splat” or “Gaussian splatting” (collectively “GS”) may refer to direct rendering of volume data without converting the data into surface or line primitives. As used herein, instances of the term “GS operation” may refer to a process or a portion of a process for performing Gaussian splatting. As used herein, instances of the term “simulated image frame” may refer to a representation of a captured image frame that is generated by a camera simulator or the like based on GS parameters. As used herein, instances of the term “GS parameters” may refer to settings, values, characteristics, etc., which may be used as inputs for GS training models. As used herein, instances of the term “GS training model” may refer to algorithms and/or machine learning (ML)/artificial intelligence (AI) models for generating digital/virtual representations of images, objects, and/or the like. As used herein, instances of the term “loss function” may refer to mathematical function for an algorithm or ML/AI model that measures model predictions for image representations against actual images to quantify any error between predicted and true values. As used herein, instances of the term “optimized simulated image frame” may refer to a representation of a captured image frame that is generated by GS ray tracing based on adjusted GS parameters and a loss function.

In some graphics processing examples, camera simulators (e.g., Internet of Things (IoT) camera simulators) may be utilized to transition image frames from 2.5D to 3D representations. GS techniques offer the potential for high-speed and photo-realistic quality renderings, yet GS quality is degraded with rasterization-based training. That is, results of GS show simulated images with photo-realistic quality when rasterization techniques are used for rendering, but not for ray tracing or other rendering techniques which fail to accurately describe important camera and lens parameters (e.g., for ray tracing). In some cases for camera simulation with rasterization, simplified light and camera models result in less realistic simulated images. However, photo-realistic quality and speed of renderings may be poor when ray tracing is used for rendering by a camera simulator with rasterization-based training. Additionally, some ray tracing techniques with generic, full parameter sets for GS applications are slow and processing intensive for renderings. Example techniques also create static world models, with stationary backgrounds and objects that do not move. Such models that lack camera/object motion do not account for rolling shutter models for training, which leads to less accurate training results that in turn affect quality and photorealism of renderings.

Aspects herein provide for training Gaussian parameters for 3D objects represented as GSs. Aspects utilize ray tracing to train the Gaussian parameters (instead of, for example, rasterization). In aspects, fine-tuning an existing optimized set of GSs using a ray tracing-based loss function may result in GSs with reduced parameters that preserve photo-realistic quality. Aspects provide for custom GS-trained models with two-level optimization that enable high photo-realistic quality of image frame representations through modified training and a new loss function with iterative optimization. Iterative optimizations for the loss function may include ML-based with peak-signal-to-noise ratio (PSNR)/structural similarity index measure (SSIM) hybrid parameter weighting. The iterative technique described herein closes the loop between camera simulation, the loss function used for GS training, and ray tracing operations. The loss function described for aspects herein utilizes a simulated image from a camera simulation engine, which previously could not be directly compared to training data using traditional PSNR and SSIM metrics. The loss function herein includes a second-level optimizer to accomplish the GS training process in order to use simulated images from the camera simulation engine. Each simulated frame may go through multiple iterations for adjustment of model parameters (e.g., camera, lens, etc.) and comparison(s) to a frame(s) from a training dataset. GSs may be created after training on a set of images of an object captured from multiple cameras to cover many different angles and/or depths. As the training nears convergence, a near optimal solution may be used to calculate the loss function. Aspects additionally provide for improved rendering speeds, e.g., GS parameters may be adjusted during training for fewer parameters (e.g., faster frames per second (fps) with fewer spherical harmonics or other parameters) or more parameters (e.g., for improved quality is certain cases). Aspects enable a unique, custom GS technique that may utilize lens-specific GS, e.g., for fisheye, telephoto, normal, etc., lenses, as well as performance photo-realistic quality improvements. Aspects also enable ray tracing to be utilized for simulating advanced camera features that may not be fully/correctly captured via rasterization (e.g., focus, defocus, rolling shutter, motion blur, and/or the like). Increased photo-realistic quality through optimized, fine-tuned GS parameter sets per-camera, per-lens, etc., e.g., for simulated fisheye 3 mm, wide 22 mm, 50 mm, and/or the like, lens models are also provided. The described training process for the aspects herein also enables adjustments for different camera models, and rectification may be skipped/refrained from during the GS training. Aspects provide for GS training directly on RAW images (e.g., uncompressed and unprocessed image data) or, for example, joint photographic experts group (JPG) images or other formats and creating 3D worlds for specific camera and lens combinations (e.g., for IoT cameras). Aspects enable the training of GSs using ray tracing of moving objects and objects/images in time. Accelerated rendering speeds are also enabled by aspects as the number of parameters utilized to represent the 3D world is minimized (e.g., spherical harmonics may be reduced significantly as decided/determined during the GS training). Aspects further provide for dynamic parametrization, e.g., each one of the GSs may have a different number of parameters, resulting in an efficient optimized representation of the 3D world. This dynamic parameterization may also defined/determined during the modified GS training process, according to aspects.

The examples describe herein may refer to a use and functionality of a graphics processing unit (GPU). As used herein, a GPU can be any type of graphics processor, and a graphics processor can be any type of processor that is designed or configured to process graphics content. For example, a graphics processor or GPU can be a specialized electronic circuit that is designed for processing graphics content. As an additional example, a graphics processor or GPU can be a general purpose processor that is configured to process graphics content.

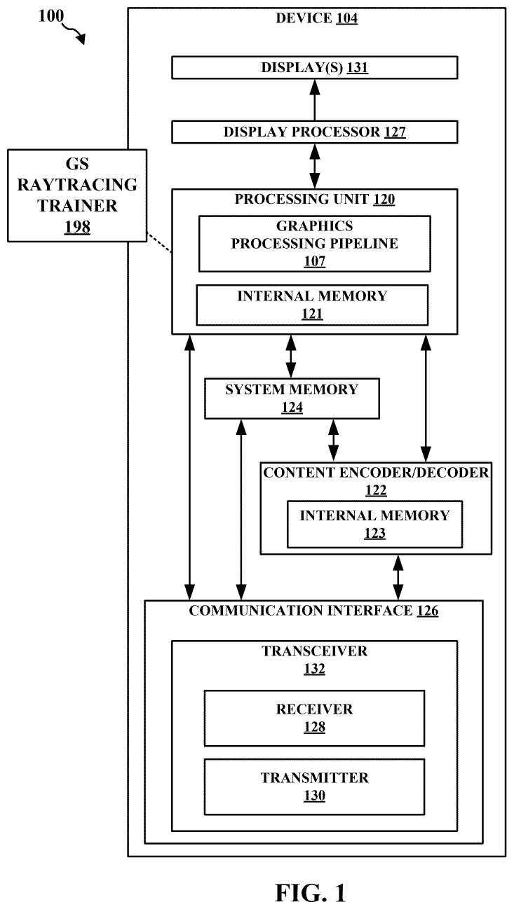

FIG. 1 is a block diagram that illustrates an example content generation system 100 configured to implement one or more techniques of this disclosure. The content generation system 100 includes a device 104. The device 104 may include one or more components or circuits for performing various functions described herein. In some examples, one or more components of the device 104 may be components of a SOC. The device 104 may include one or more components configured to perform one or more techniques of this disclosure. In the example shown, the device 104 may include a processing unit 120, a content encoder/decoder 122, and a system memory 124. In some aspects, the device 104 may include a number of components (e.g., a communication interface 126, a transceiver 132, a receiver 128, a transmitter 130, a display processor 127, and one or more displays 131). Display(s) 131 may refer to one or more displays 131. For example, the display 131 may include a single display or multiple displays, which may include a first display and a second display. The first display may be a left-eye display and the second display may be a right-eye display. In some examples, the first display and the second display may receive different frames for presentment thereon. In other examples, the first and second display may receive the same frames for presentment thereon. In further examples, the results of the graphics processing may not be displayed on the device, e.g., the first display and the second display may not receive any frames for presentment thereon. Instead, the frames or graphics processing results may be transferred to another device. In some aspects, this may be referred to as split-rendering.

The processing unit 120 may include an internal memory 121. The processing unit 120 may be configured to perform graphics processing using a graphics processing pipeline 107. The content encoder/decoder 122 may include an internal memory 123. In some examples, the device 104 may include a processor, which may be configured to perform one or more display processing techniques on one or more frames generated by the processing unit 120 before the frames are displayed by the one or more displays 131. While the processor in the example content generation system 100 is configured as a display processor 127, it should be understood that the display processor 127 is one example of the processor and that other types of processors, controllers, etc., may be used as substitute for the display processor 127. The display processor 127 may be configured to perform display processing. For example, the display processor 127 may be configured to perform one or more display processing techniques on one or more frames generated by the processing unit 120. The one or more displays 131 may be configured to display or otherwise present frames processed by the display processor 127. In some examples, the one or more displays 131 may include one or more of a liquid crystal display (LCD), a plasma display, an organic light emitting diode (OLED) display, a projection display device, an augmented reality display device, a virtual reality display device, a head-mounted display, or any other type of display device.

Memory external to the processing unit 120 and the content encoder/decoder 122, such as system memory 124, may be accessible to the processing unit 120 and the content encoder/decoder 122. For example, the processing unit 120 and the content encoder/decoder 122 may be configured to read from and/or write to external memory, such as the system memory 124. The processing unit 120 may be communicatively coupled to the system memory 124 over a bus. In some examples, the processing unit 120 and the content encoder/decoder 122 may be communicatively coupled to the internal memory 121 over the bus or via a different connection.

The content encoder/decoder 122 may be configured to receive graphical content from any source, such as the system memory 124 and/or the communication interface 126. The system memory 124 may be configured to store received encoded or decoded graphical content. The content encoder/decoder 122 may be configured to receive encoded or decoded graphical content, e.g., from the system memory 124 and/or the communication interface 126, in the form of encoded pixel data. The content encoder/decoder 122 may be configured to encode or decode any graphical content.

The internal memory 121 or the system memory 124 may include one or more volatile or non-volatile memories or storage devices. In some examples, internal memory 121 or the system memory 124 may include RAM, static random access memory (SRAM), dynamic random access memory (DRAM), erasable programmable ROM (EPROM), EEPROM, flash memory, a magnetic data media or an optical storage media, or any other type of memory. The internal memory 121 or the system memory 124 may be a non-transitory storage medium according to some examples. The term “non-transitory” may indicate that the storage medium is not embodied in a carrier wave or a propagated signal. However, the term “non-transitory” should not be interpreted to mean that internal memory 121 or the system memory 124 is non-movable or that its contents are static. As one example, the system memory 124 may be removed from the device 104 and moved to another device. As another example, the system memory 124 may not be removable from the device 104.

The processing unit 120 may be a CPU, a GPU, a GPGPU, or any other processing unit that may be configured to perform graphics processing. In some examples, the processing unit 120 may be integrated into a motherboard of the device 104. In further examples, the processing unit 120 may be present on a graphics card that is installed in a port of the motherboard of the device 104, or may be otherwise incorporated within a peripheral device configured to interoperate with the device 104. The processing unit 120 may include one or more processors, such as one or more microprocessors, GPUs, ASICs, FPGAs, arithmetic logic units (ALUs), DSPs, discrete logic, software, hardware, firmware, other equivalent integrated or discrete logic circuitry, or any combinations thereof. If the techniques are implemented partially in software, the processing unit 120 may store instructions for the software in a suitable, non-transitory computer-readable storage medium, e.g., internal memory 121, and may execute the instructions in hardware using one or more processors to perform the techniques of this disclosure. Any of the foregoing, including hardware, software, a combination of hardware and software, etc., may be considered to be one or more processors.

The content encoder/decoder 122 may be any processing unit configured to perform content decoding. In some examples, the content encoder/decoder 122 may be integrated into a motherboard of the device 104. The content encoder/decoder 122 may include one or more processors, such as one or more microprocessors, application specific integrated circuits (ASICs), field programmable gate arrays (FPGAs), arithmetic logic units (ALUs), digital signal processors (DSPs), video processors, discrete logic, software, hardware, firmware, other equivalent integrated or discrete logic circuitry, or any combinations thereof. If the techniques are implemented partially in software, the content encoder/decoder 122 may store instructions for the software in a suitable, non-transitory computer-readable storage medium, e.g., internal memory 123, and may execute the instructions in hardware using one or more processors to perform the techniques of this disclosure. Any of the foregoing, including hardware, software, a combination of hardware and software, etc., may be considered to be one or more processors.

In some aspects, the content generation system 100 may include a communication interface 126. The communication interface 126 may include a receiver 128 and a transmitter 130. The receiver 128 may be configured to perform any receiving function described herein with respect to the device 104. Additionally, the receiver 128 may be configured to receive information, e.g., eye or head position information, rendering commands, and/or location information, from another device. The transmitter 130 may be configured to perform any transmitting function described herein with respect to the device 104. For example, the transmitter 130 may be configured to transmit information to another device, which may include a request for content. The receiver 128 and the transmitter 130 may be combined into a transceiver 132. In such examples, the transceiver 132 may be configured to perform any receiving function and/or transmitting function described herein with respect to the device 104.

Referring again to FIG. 1, in certain aspects, the processing unit 120 may include a GS ray tracing trainer 198 configured to generate a simulated image frame based on an input image frame and a first set of GS parameters associated with a GS training model and a first ray tracing operation, to determine a second set of GS parameters based on the simulated image frame and a loss function, to generate an optimized simulated image frame based on the simulated image frame, the second set of GS parameters, and a second ray tracing operation, and to output the optimized simulated image frame. The GS ray tracing trainer 198 may also be configured to adjust a number of GS parameters of the set of GS parameters based on the loss function associated with the GS training model to obtain the adjusted number of GS parameters, where the loss function is a ray tracing-based loss function. The GS ray tracing trainer 198 may also be configured to obtain the set of GS parameters for the simulated image frame based on the GS training model for the first ray tracing operation. The GS ray tracing trainer 198 may also be configured to train the GS training model based on a set of prior simulated image frames, and to generate the loss function based on the trained GS training model. Although the following description may be focused on graphics processing, the concepts described herein may be applicable to other similar processing techniques.

A device, such as the device 104, may refer to any device, apparatus, or system configured to perform one or more techniques described herein. For example, a device may be a server, a base station, a user equipment, a client device, a station, an access point, a computer such as a personal computer, a desktop computer, a laptop computer, a tablet computer, a computer workstation, or a mainframe computer, an end product, an apparatus, a phone, a smart phone, a server, a video game platform or console, a handheld device such as a portable video game device or a personal digital assistant (PDA), a wearable computing device such as a smart watch, an augmented reality device, or a virtual reality device, a non-wearable device, a display or display device, a television, a television set-top box, an intermediate network device, a digital media player, a video streaming device, a content streaming device, an in-vehicle computer, any mobile device, any device configured to generate graphical content, or any device configured to perform one or more techniques described herein. Processes herein may be described as performed by a particular component (e.g., a GPU) but in other embodiments, may be performed using other components (e.g., a CPU) consistent with the disclosed embodiments.

GPUs can process multiple types of data or data packets in a GPU pipeline. For instance, in some aspects, a GPU can process two types of data or data packets, e.g., context register packets and draw call data. A context register packet can be a set of global state information, e.g., information regarding a global register, shading program, or constant data, which can regulate how a graphics context will be processed. For example, context register packets can include information regarding a color format. In some aspects of context register packets, there can be a bit or bits that indicate which workload belongs to a context register. Also, there can be multiple functions or programming running at the same time and/or in parallel. For example, functions or programming can describe a certain operation, e.g., the color mode or color format. Accordingly, a context register can define multiple states of a GPU.

Context states can be utilized to determine how an individual processing unit functions, e.g., a vertex fetcher (VFD), a vertex shader (VS), a shader processor, or a geometry processor, and/or in what mode the processing unit functions. In order to do so, GPUs can use context registers and programming data. In some aspects, a GPU can generate a workload, e.g., a vertex or pixel workload, in the pipeline based on the context register definition of a mode or state. Certain processing units, e.g., a VFD, can use these states to determine certain functions, e.g., how a vertex is assembled. As these modes or states can change, GPUs may need to change the corresponding context. Additionally, the workload that corresponds to the mode or state may follow the changing mode or state.

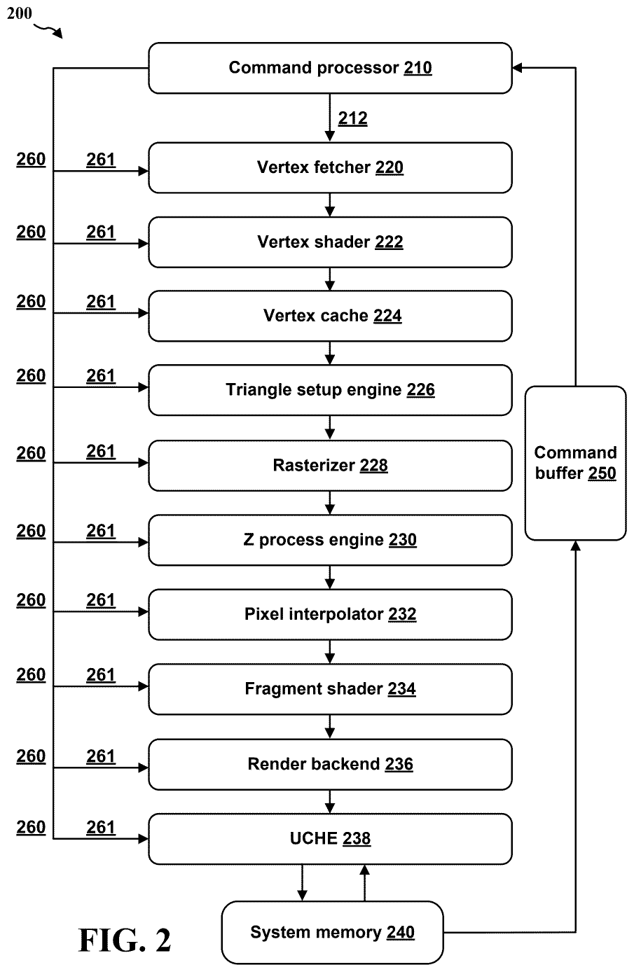

FIG. 2 illustrates an example GPU 200 in accordance with one or more techniques of this disclosure. As shown in FIG. 2, GPU 200 includes command processor (CP) 210, draw call packets 212, VFD 220, VS 222, vertex cache (VPC) 224, triangle setup engine (TSE) 226, rasterizer (RAS) 228, Z process engine (ZPE) 230, pixel interpolator (PI) 232, fragment shader (FS) 234, render backend (RB) 236, L2 cache (UCHE) 238, and system memory 240. Although FIG. 2 displays that GPU 200 includes processing units 220-238, GPU 200 can include a number of additional processing units. Additionally, processing units 220-238 are merely an example and any combination or order of processing units can be used by GPUs according to the present disclosure. GPU 200 also includes command buffer 250, context register packets 260, and context states 261.

As shown in FIG. 2, a GPU can utilize a CP, e.g., CP 210, or hardware accelerator to parse a command buffer into context register packets, e.g., context register packets 260, and/or draw call data packets, e.g., draw call packets 212. The CP 210 can then send the context register packets 260 or draw call data packets 212 through separate paths to the processing units or blocks in the GPU. Further, the command buffer 250 can alternate different states of context registers and draw calls. For example, a command buffer can simultaneously store the following information: context register of context N, draw call(s) of context N, context register of context N+1, and draw call(s) of context N+1.

GPUs can render images in a variety of different ways. In some instances, GPUs can render an image using direct rendering and/or tiled rendering. In tiled rendering GPUs, an image can be divided or separated into different sections or tiles. After the division of the image, each section or tile can be rendered separately. Tiled rendering GPUs can divide computer graphics images into a grid format, such that each portion of the grid, i.e., a tile, is separately rendered. In some aspects of tiled rendering, during a binning pass, an image can be divided into different bins or tiles. In some aspects, during the binning pass, a visibility stream can be constructed where visible primitives or draw calls can be identified. A rendering pass may be performed after the binning pass. In contrast to tiled rendering, direct rendering does not divide the frame into smaller bins or tiles. Rather, in direct rendering, the entire frame is rendered at a single time (i.e., without a binning pass). Additionally, some types of GPUs can allow for both tiled rendering and direct rendering (e.g., flex rendering).

In some aspects, GPUs can apply the drawing or rendering process to different bins or tiles. For instance, a GPU can render to one bin, and perform all the draws for the primitives or pixels in the bin. During the process of rendering to a bin, the render targets can be located in GPU internal memory (GMEM). In some instances, after rendering to one bin, the content of the render targets can be moved to a system memory and the GMEM can be freed for rendering the next bin. Additionally, a GPU can render to another bin, and perform the draws for the primitives or pixels in that bin. Therefore, in some aspects, there might be a small number of bins, e.g., four bins, that cover all of the draws in one surface. Further, GPUs can cycle through all of the draws in one bin, but perform the draws for the draw calls that are visible, i.e., draw calls that include visible geometry. In some aspects, a visibility stream can be generated, e.g., in a binning pass, to determine the visibility information of each primitive in an image or scene. For instance, this visibility stream can identify whether a certain primitive is visible or not. In some aspects, this information can be used to remove primitives that are not visible so that the non-visible primitives are not rendered, e.g., in the rendering pass. Also, at least some of the primitives that are identified as visible can be rendered in the rendering pass.

In some aspects of tiled rendering, there can be multiple processing phases or passes. For instance, the rendering can be performed in two passes, e.g., a binning, a visibility or bin-visibility pass and a rendering or bin-rendering pass. During a visibility pass, a GPU can input a rendering workload, record the positions of the primitives or triangles, and then determine which primitives or triangles fall into which bin or area. In some aspects of a visibility pass, GPUs can also identify or mark the visibility of each primitive or triangle in a visibility stream. During a rendering pass, a GPU can input the visibility stream and process one bin or area at a time. In some aspects, the visibility stream can be analyzed to determine which primitives, or vertices of primitives, are visible or not visible. As such, the primitives, or vertices of primitives, that are visible may be processed. By doing so, GPUs can reduce the unnecessary workload of processing or rendering primitives or triangles that are not visible.

In some aspects, during a visibility pass, certain types of primitive geometry, e.g., position-only geometry, may be processed. Additionally, depending on the position or location of the primitives or triangles, the primitives may be sorted into different bins or areas. In some instances, sorting primitives or triangles into different bins may be performed by determining visibility information for these primitives or triangles. For example, GPUs may determine or write visibility information of each primitive in each bin or area, e.g., in a system memory. This visibility information can be used to determine or generate a visibility stream. In a rendering pass, the primitives in each bin can be rendered separately. In these instances, the visibility stream can be fetched from memory and used to remove primitives which are not visible for that bin.

Some aspects of GPUs or GPU architectures can provide a number of different options for rendering, e.g., software rendering and hardware rendering. In software rendering, a driver or CPU can replicate an entire frame geometry by processing each view one time. Additionally, some different states may be changed depending on the view. As such, in software rendering, the software can replicate the entire workload by changing some states that may be utilized to render for each viewpoint in an image. In certain aspects, as GPUs may be submitting the same workload multiple times for each viewpoint in an image, there may be an increased amount of overhead. In hardware rendering, the hardware or GPU may be responsible for replicating or processing the geometry for each viewpoint in an image. Accordingly, the hardware can manage the replication or processing of the primitives or triangles for each viewpoint in an image.

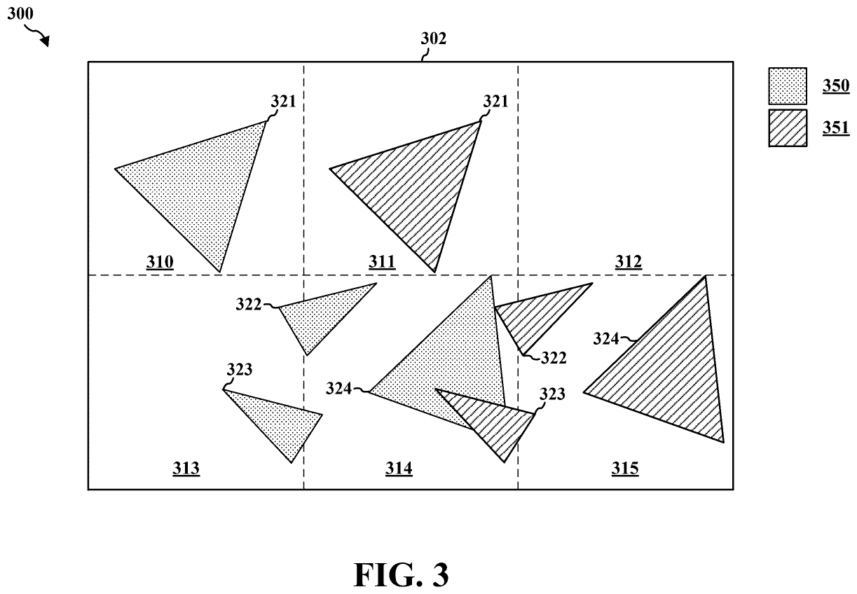

FIG. 3 illustrates image or surface 300, including multiple primitives divided into multiple bins in accordance with one or more techniques of this disclosure. As shown in FIG. 3, image or surface 300 includes area 302, which includes primitives 321, 322, 323, and 324. The primitives 321, 322, 323, and 324 are divided or placed into different bins, e.g., bins 310, 311, 312, 313, 314, and 315. FIG. 3 illustrates an example of tiled rendering using multiple viewpoints for the primitives 321-324. For instance, primitives 321-324 are in first viewpoint 350 and second viewpoint 351. As such, the GPU processing or rendering the image or surface 300 including area 302 can utilize multiple viewpoints or multi-view rendering.

As indicated herein, GPUs or graphics processors can use a tiled rendering architecture to reduce power consumption or save memory bandwidth. As further stated above, this rendering method can divide the scene into multiple bins, as well as include a visibility pass that identifies the triangles that are visible in each bin. Thus, in tiled rendering, a full screen can be divided into multiple bins or tiles. The scene can then be rendered multiple times, e.g., one or more times for each bin.

In aspects of graphics rendering, some graphics applications may render to a single target, i.e., a render target, one or more times. For instance, in graphics rendering, a frame buffer on a system memory may be updated multiple times. The frame buffer can be a portion of memory or random access memory (RAM), e.g., containing a bitmap or storage, to help store display data for a GPU. The frame buffer can also be a memory buffer containing a complete frame of data. Additionally, the frame buffer can be a logic buffer. In some aspects, updating the frame buffer can be performed in bin or tile rendering, where, as discussed above, a surface is divided into multiple bins or tiles and then each bin or tile can be separately rendered. Further, in tiled rendering, the frame buffer can be partitioned into multiple bins or tiles.

As indicated herein, in some aspects, such as in bin or tiled rendering architecture, frame buffers can have data stored or written to them repeatedly, e.g., when rendering from different types of memory. This can be referred to as resolving and unresolving the frame buffer or system memory. For example, when storing or writing to one frame buffer and then switching to another frame buffer, the data or information on the frame buffer can be resolved from the GMEM at the GPU to the system memory, i.e., memory in the double data rate (DDR) RAM or dynamic RAM (DRAM).

In some aspects, the system memory can also be system-on-chip (SoC) memory or another chip-based memory to store data or information, e.g., on a device or smart phone. The system memory can also be physical data storage that is shared by the CPU and/or the GPU. In some aspects, the system memory can be a DRAM chip, e.g., on a device or smart phone. Accordingly, SoC memory can be a chip-based manner in which to store data.

In some aspects, the GMEM can be on-chip memory at the GPU, which can be implemented by static RAM (SRAM). Additionally, GMEM can be stored on a device, e.g., a smart phone. As indicated herein, data or information can be transferred between the system memory or DRAM and the GMEM, e.g., at a device. In some aspects, the system memory or DRAM can be at the CPU or GPU. Additionally, data can be stored at the DDR or DRAM. In some aspects, such as in bin or tiled rendering, a small portion of the memory can be stored at the GPU, e.g., at the GMEM. In some instances, storing data at the GMEM may utilize a larger processing workload and/or consume more power compared to storing data at the frame buffer or system memory.

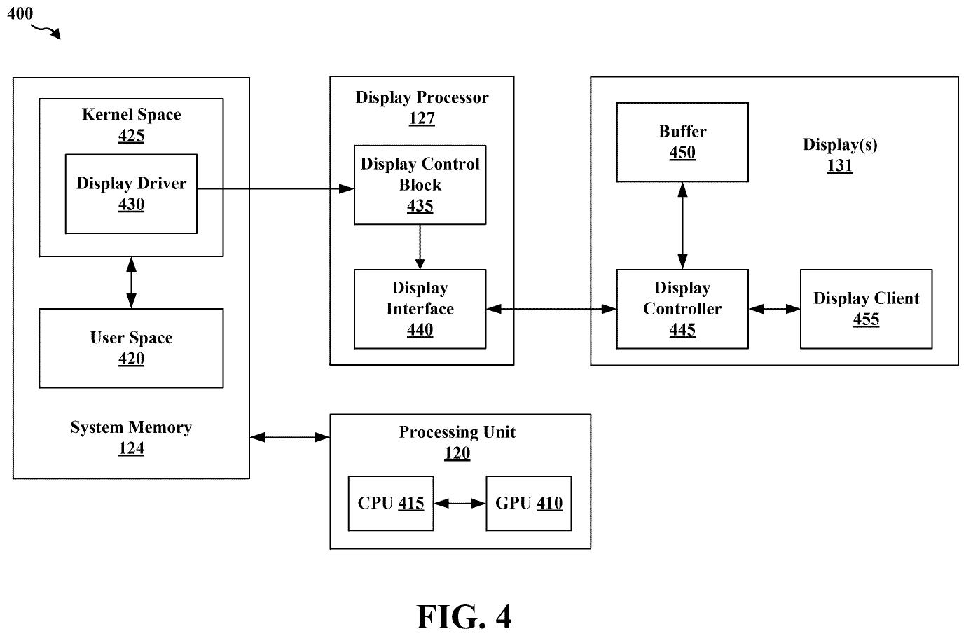

FIG. 4 is a block diagram 400 that illustrates an example display framework including the processing unit 120, the system memory 124, the display processor 127, and the display(s) 131, as may be identified in connection with the device 104.

A GPU may be included in devices that provide content for visual presentation on a display. For example, the processing unit 120 may include a GPU 410 configured to render graphical data for display on a computing device (e.g., the device 104), which may be a computer workstation, a mobile phone, a smartphone or other smart device, an embedded system, a personal computer, a tablet computer, a video game console, and the like. Operations of the GPU 410 may be controlled based on one or more graphics processing commands provided by a CPU 415. The CPU 415 may be configured to execute multiple applications concurrently. In some cases, each of the concurrently executed multiple applications may utilize the GPU 410 simultaneously. Processing techniques may be performed via the processing unit 120 output a frame over physical or wireless communication channels.

The system memory 124, which may be executed by the processing unit 120, may include a user space 420 and a kernel space 425. The user space 420 (sometimes referred to as an “application space”) may include software application(s) and/or application framework(s). For example, software application(s) may include operating systems, media applications, graphical applications, workspace applications, etc. Application framework(s) may include frameworks used by one or more software applications, such as libraries, services (e.g., display services, input services, etc.), application program interfaces (APIs), etc. The kernel space 425 may further include a display driver 430. The display driver 430 may be configured to control the display processor 127. For example, the display driver 430 may cause the display processor 127 to compose a frame and transmit the data for the frame to a display.

The display processor 127 includes a display control block 435 and a display interface 440. The display processor 127 may be configured to manipulate functions of the display(s) 131 (e.g., based on an input received from the display driver 430). The display control block 435 may be further configured to output image frames to the display(s) 131 via the display interface 440. In some examples, the display control block 435 may additionally or alternatively perform post-processing of image data provided based on execution of the system memory 124 by the processing unit 120.

The display interface 440 may be configured to cause the display(s) 131 to display image frames. The display interface 440 may output image data to the display(s) 131 according to an interface protocol, such as, for example, the MIPI DSI (Mobile Industry Processor Interface, Display Serial Interface). That is, the display(s) 131, may be configured in accordance with MIPI DSI standards. The MIPI DSI standard supports a video mode and a command mode. In examples where the display(s) 131 is/are operating in video mode, the display processor 127 may continuously refresh the graphical content of the display(s) 131. For example, the entire graphical content may be refreshed per refresh cycle (e.g., line-by-line). In examples where the display(s) 131 is/are operating in command mode, the display processor 127 may write the graphical content of a frame to a buffer 450.

In some such examples, the display processor 127 may not continuously refresh the graphical content of the display(s) 131. Instead, the display processor 127 may use a vertical synchronization (Vsync) pulse to coordinate rendering and consuming of graphical content at the buffer 450. For example, when a Vsync pulse is generated, the display processor 127 may output new graphical content to the buffer 450. Thus, generation of the Vsync pulse may indicate that current graphical content has been rendered at the buffer 450.

Frames are displayed at the display(s) 131 based on a display controller 445, a display client 455, and the buffer 450. The display controller 445 may receive image data from the display interface 440 and store the received image data in the buffer 450. In some examples, the display controller 445 may output the image data stored in the buffer 450 to the display client 455. Thus, the buffer 450 may represent a local memory to the display(s) 131. In some examples, the display controller 445 may output the image data received from the display interface 440 directly to the display client 455.

The display client 455 may be associated with a touch panel that senses interactions between a user and the display(s) 131. As the user interacts with the display(s) 131, one or more sensors in the touch panel may output signals to the display controller 445 that indicate which of the one or more sensors have sensor activity, a duration of the sensor activity, an applied pressure to the one or more sensor, etc. The display controller 445 may use the sensor outputs to determine a manner in which the user has interacted with the display(s) 131. The display(s) 131 may be further associated with/include other devices, such as a camera, a microphone, and/or a speaker, that operate in connection with the display client 455.

Some processing techniques of the device 104 may be performed over three stages (e.g., stage 1: a rendering stage; stage 2: a composition stage; and stage 3: a display/transfer stage). However, other processing techniques may combine the composition stage and the display/transfer stage into a single stage, such that the processing technique may be executed based on two total stages (e.g., stage 1: the rendering stage; and stage 2: the composition/display/transfer stage). During the rendering stage, the GPU 410 may process a content buffer based on execution of an application that generates content on a pixel-by-pixel basis. During the composition and display stage(s), pixel elements may be assembled to form a frame that is transferred to a physical display panel/subsystem (e.g., the displays 131) that displays the frame.

Instructions executed by a CPU (e.g., software instructions) or a display processor may cause the CPU or the display processor to search for and/or generate a composition strategy for composing a frame based on a dynamic priority and runtime statistics associated with one or more composition strategy groups. A frame to be displayed by a physical display device, such as a display panel, may include a plurality of layers. Also, composition of the frame may be based on combining the plurality of layers into the frame (e.g., based on a frame buffer). After the plurality of layers are combined into the frame, the frame may be provided to the display panel for display thereon. The process of combining each of the plurality of layers into the frame may be referred to as composition, frame composition, a composition procedure, a composition process, or the like.

A frame composition procedure or composition strategy may correspond to a technique for composing different layers of the plurality of layers into a single frame. The plurality of layers may be stored in doubled data rate (DDR) memory. Each layer of the plurality of layers may further correspond to a separate buffer. A composer or hardware composer (HWC) associated with a block or function may determine an input of each layer/buffer and perform the frame composition procedure to generate an output indicative of a composed frame. That is, the input may be the layers and the output may be a frame composition procedure for composing the frame to be displayed on the display panel.

Some aspects of display processing may utilize different types of mask layers, e.g., a shape mask layer. A mask layer is a layer that may represent a portion of a display or display panel. For instance, an area of a mask layer may correspond to an area of a display, but the entire mask layer may depict a portion of the content that is actually displayed at the display or panel. For example, a mask layer may include a top portion and a bottom portion of a display area, but the middle portion of the mask layer may be empty. In some examples, there may be multiple mask layers to represent different portions of a display area. Also, for certain portions of a display area, the content of different mask layers may overlap with one another. Accordingly, a mask layer may represent a portion of a display area that may or may not overlap with other mask layers.

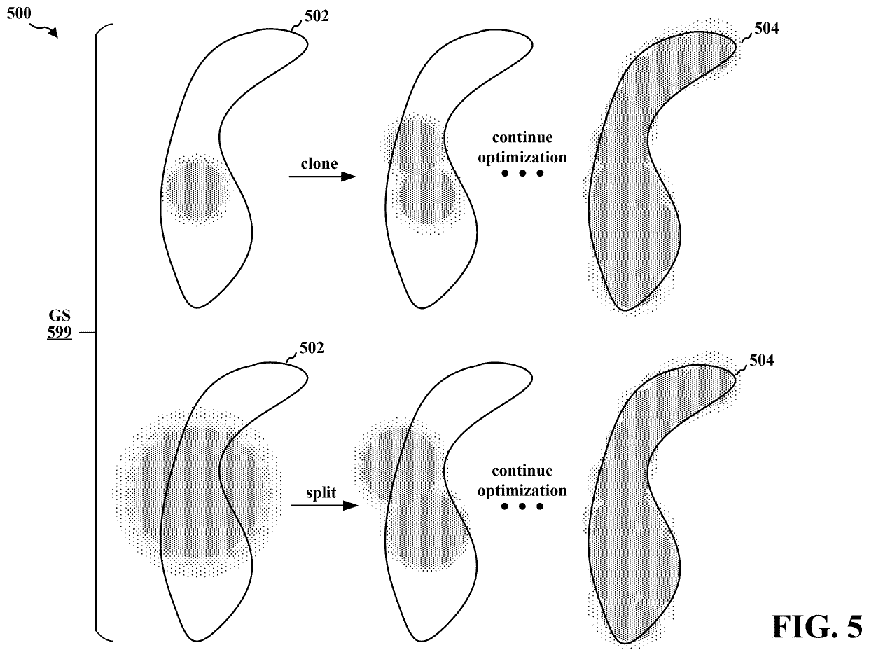

FIG. 5 illustrates a diagram 500 for examples of GS image representation in accordance with one or more techniques of this disclosure. Diagram 500 is shown in the context of an object 502 for which GS 599 generates a representation 504.

In some case, GS may be used in a cloning approach, while in other cases, a splitting approach for a larger initial GS may be used. In both cases, randomly initialized GSs may be applied against an outline of the object 502 or a portion of the object 502. Optimizations may be made using gradient descent scaling and by rotating the object 502. Techniques may reduce a number of objects in the scene, and a number of GSs may be less than the points in a point cloud.

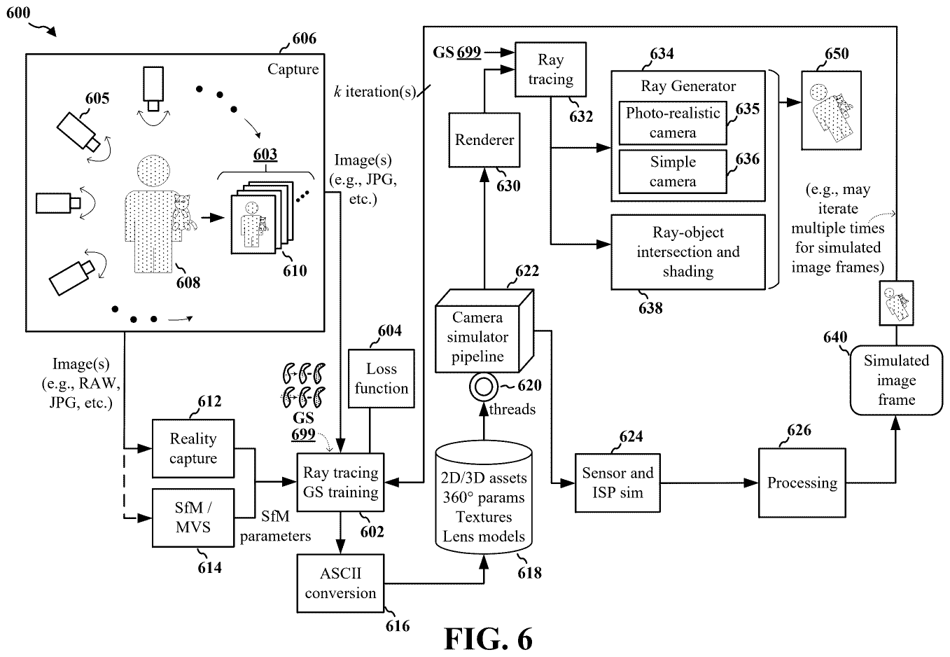

FIG. 6 illustrates a diagram 600 of a system flow for GS ray tracing for photo-realistic simulations in accordance with one or more techniques of this disclosure. Diagram 600 shows ray tracing GS training 602 and a loss function 604 (which may be an aspect of a loss function(s) described herein) utilized for application of GS 699, as described herein, in a camera simulator pipeline 622. In aspects, one or more blocks of diagram 600 may be performed by a processing unit/a graphics processor, as described herein.

The camera simulator pipeline 622 may include capturing images (e.g., use a device such as a camera/IoT camera) to capture raw input images of an object from various angles and provide constant raw photos without settings changes), may include structure from motion (SfM)/multi-view stereo (MVS) (e.g., for asset creation using the images captured and to create point cloud using a photogrammetry pipeline), may include 3D Gaussian Splatting (3DGS) (e.g., GS as described herein for 3D representations by training and/or updating of 3DGS on the input images and training and/or updating along with a loss function 604 comparison for the input images, may include scene clean up (e.g., the 3DGS may return a file with an entire scene (such as background and object), and may isolate the object desired for rendering and remove the rest of the scene), and may include camera simulator ray tracing (e.g., import the isolated object and follow the ray tracing pipeline for ray tracing of 3DGS with maximum intensity methods). Training, e.g., in the context of the ray tracing GS training 602 (including associated parameters, an associated GS training model(s), and/or the like), may include updating, and likewise, updating may include training, in the described aspects herein. As one example, after an initial training for the ray tracing GS training 602, further training for the ray tracing GS training 602, e.g., during training iterations may, be referred to as training and/or updating of the ray tracing GS training 602.

A set of cameras 605 may capture (at 606) a set of images 610 of an object 608, e.g., as GS asset creation. In aspects, the set of cameras may include any number of cameras at various angles and/or positions relative to the object 608. In some aspects, the set of cameras may be a set of IoT cameras and/or a set of virtual cameras. Some images of the set of images 610, e.g., JPG images, may be provided to the ray tracing GS training 602, while some images of the set of images 610, e.g., RAW/JPG images, may be provided for reality capture 612 and/or for SfM/MVS 614 (e.g., COLMAP). From the reality capture 612 and/or the SfM)/MVS 614, SfM parameters may be provided to the ray tracing GS training 602 as a training input(s).

The ray tracing GS training 602 may also receive a simulated image frame 640 as a training input. The simulated image frame 640 may be generated based on an American Standard Code for Information Interchange (ASCII) conversion 616 of the training output from the ray tracing GS training 602, which may include assets and models 618. The assets and models 618 may include, without limitation, 2D assets, 3D assets, 360° parameters for 3D (e.g., Skybox), textures, lens models, camera models, and/or the like, and may be provided for threads 620 associated with the camera simulator pipeline 622. Sensor and image signal processing (ISP) simulation 624 may then be performed, followed by processing 626, to generate the simulated image frame 640. The processing 626 may include, without limitation, mosaic processing, noise adding processing, application of auto-focus (AF) statistics, de-mosaic processing, gamma correction, and/or the like, according to aspects. As noted, the simulated image frame 640 is fed back to the ray tracing GS training 602 to determine if convergence is approached/met for the loss function 604.

The ray tracing GS training 602 may determine and utilize a first set of GS parameters (e.g., associated with the ray tracing GS training 602 model and a first ray tracing operation) for generating the simulated image frame 640 based on an input image frame 603 associated with the set of images 610 in a first training iteration (e.g., of a number ‘k’ of iterations. The ray tracing GS training 602 may subsequently adjust GS parameters and/or numbers of parameters during a given training iteration (e.g., to generate a second set of GS parameters in a second iteration (and/or additional sets of GS parameters in additional iteration) to move toward convergence. In aspects, GS parameters may include, without limitation, a set of GS characteristics, a set of per camera GS parameters, a set of per lens GS parameters, a set of object GS parameters, and/or the like. The set of GS characteristics may include at least one of a position, a location, a covariance, a color, an opacity, a set of spherical harmonics, etc., the set of per camera GS parameters may include at least one of an exposure setting, an aperture setting, a rolling shutter speed, a motion parameter, a pose parameter, an analog gain, a digital gain, etc., the set of per lens GS parameters may include at least one of a normal lens parameter, a fisheye lens parameter, a wide-angle lens parameter, a telephoto lens parameter, etc., and the set of object GS parameters may include at least one of a motion vector, a rotation parameter, etc. A given instance of the simulated image frame 640 may be iterated upon multiple times (e.g., k iterations) by the ray tracing GS training 602, which may be utilized any number of input images from the set of images 610 for each iteration. In this way, motion and changes in time of the object 608 may be utilized for the ray tracing GS training 602.

Based on a convergence of the ray tracing GS training 602, the loss function 604 may be determined in order to provide photo-realistic quality of an output, e.g., the optimized simulated image frame 650, based on adjusted GC parameters, e.g., reduced/changed GC parameters, lens- and/or camera-specific GC parameters, and/or the like, as described herein for aspects. The convergence of the ray tracing GS training 602, and the loss function 604, may result in a set of adjusted GC parameters to be utilized by a renderer 630 for rendering via ray tracing 632. The ray tracing 632 may be associated with a ray generator 634 (e.g., which may include a photo-realistic camera 635 and/or a simple camera 636) and ray-object intersection and shading 638 to generate the optimized simulated image frame 650 as output (e.g., for a memory, for additional processing, for provision to a display panel, and/or the like).

The loss function 604 may utilize a simulated image from a camera simulation engine, which previously could not be directly compared to training data using traditional PSNR and SSIM metrics. The loss function 604 may include a second-level optimizer to accomplish the ray tracing GS training 602 in order to use simulated images from the camera simulation engine. Each simulated frame may go through multiple iterations (e.g., the k iterations) for adjustment(s) of model parameters (e.g., camera, lens, etc.) and comparison(s) to a frame(s) from a training dataset. GSs may be created after training on a set of images of an object captured from multiple cameras to cover many different angles and/or depths. As the training nears convergence, a near optimal solution may be used to calculate loss function 604. Aspects additionally provide for improved rendering speeds, e.g., GS parameters may be adjusted during training for fewer parameters (e.g., faster frames per second (fps) with fewer spherical harmonics or other parameters) or more parameters (e.g., for improved quality is certain cases). Aspects enable a unique, custom GS technique that may utilize lens-specific GS, e.g., for fisheye, telephoto, normal, etc., lenses, as well as performance photo-realistic quality improvements. Aspects also enable ray tracing to be utilized for simulating advanced camera features that may not be fully/correctly captured via rasterization (e.g., focus, defocus, rolling shutter, motion blur, and/or the like). Increased photo-realistic quality through optimized, fine-tuned GS parameter sets per-camera, per-lens, etc., e.g., for simulated fisheye 3 mm, wide 22 mm, 50 mm, and/or the like, lens models are also provided. The described training process for the aspects herein also enables adjustments for different camera models, and rectification may be skipped/refrained from during the ray tracing GS training 602. For instance, rectification is typically used for large field of view (FoV) fisheye lenses, and when the training images have significant lens distortion (e.g., as is common with wide-angle lenses, such as radial distortion and decentering distortion), rectification may be employed to improve the accuracy and reliability of the camera pose estimation. Rectification may refer to estimating the parameters of the distortion model and may include estimating the center of the image. Image rectification may be formed as an optimization problem to minimize some energy and/or loss terms that are used to measure the distortions in the image. Aspects herein obviate the use of rectification (e.g., no rectification is performed), which results in a faster end-to-end pipeline and more accurate GS parameter estimations.

Aspects provide for the ray tracing GS training 602 directly on RAW/JPG images and creating 3D worlds for specific camera and lens combinations (e.g., for IoT cameras). Accelerated rendering speeds are also enabled by aspects as the number of parameters utilized to represent the 3D world is minimized (e.g., spherical harmonics may be reduced significantly as decided/determined during the ray tracing GS training 602). Aspects further provide for dynamic parametrization, e.g., each one of the GSs may have a different number of parameters, resulting in efficient optimized representation of the 3D world. This dynamic parameterization may also defined/determined during the ray tracing GS training 602, according to aspects.

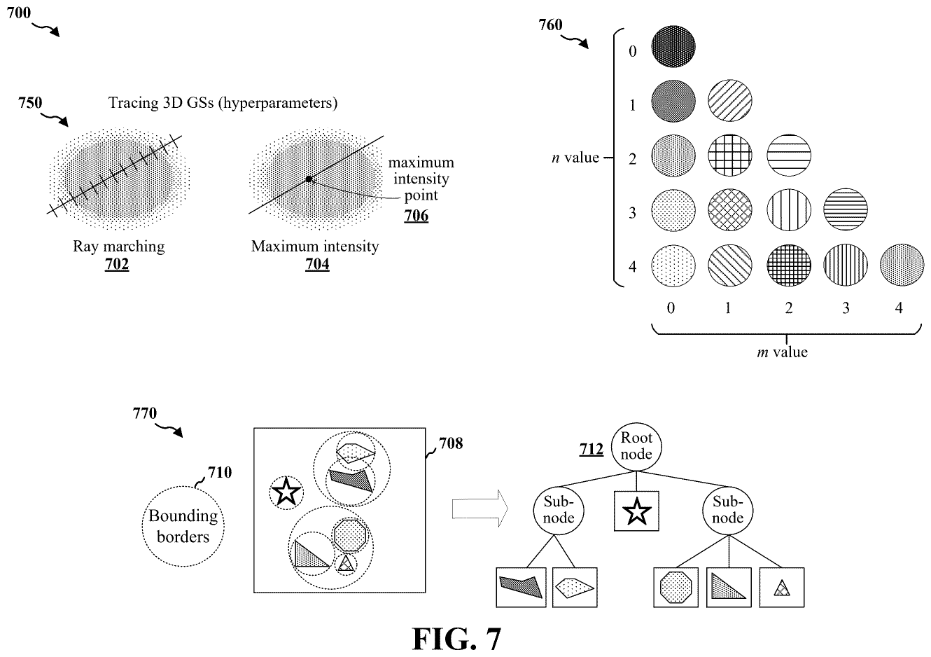

FIG. 7 illustrates a diagram 700 of example optimizations for GS ray tracing for photo-realistic simulations in accordance with one or more techniques of this disclosure.

Tracing 3D GSs 750 (e.g., via hyperparameters) is shown for ray marching 702 and for maximum intensity 704, for aspects herein. Ray marching 702 be used to integrate throughout the densities of a 3D GS. The “march” distance may be set between each step, and this technique may be computationally expensive marching through each individual GS. For the maximum intensity 704, a maximum intensity point 706 along a particular ray and Gaussian distribution may be calculated, and a Gaussian distribution formula may be used to calculate density at given point.

One optimization associated with GS parameters is spherical harmonics. Spherical harmonics 760 are shown, by way of example, as compact encoded lighting effects based on dimensional pairs [m, n]. In aspects, higher values for m and/or n may result in improved quality of rendered images at a cost of higher computation/latency. In aspects, GS training and loss functions herein may reduce the utilized number of harmonics available from spherical harmonics 760 to improve computation/latency metrics, while maintaining photo-realistic quality of renderings with ray tracing.

A bounded volume hierarchy 770 (also a “BVH”) is shown as another optimization associated with GS parameters. Objects in a scene 708 may be bounded by bounding borders 710 to delineate groups of objects. A nested tree structure 712 may be utilized to organize the objects hierarchically by breaking the scene 708 into equal parts to avoid unnecessary tracing. From a root node, sub-nodes and objects within one of the bounding borders 710 may form a first level of the bounded volume hierarchy 770, while objects within two of the bounding borders 710 may form a second level of the bounded volume hierarchy 770, and so on. Any number of levels/sub-nodes may be utilized for the bounded volume hierarchy 770, in aspects. In some configurations, the aspects herein may be carried out/performed with or on dedicated device hardware for ray tracing objects.

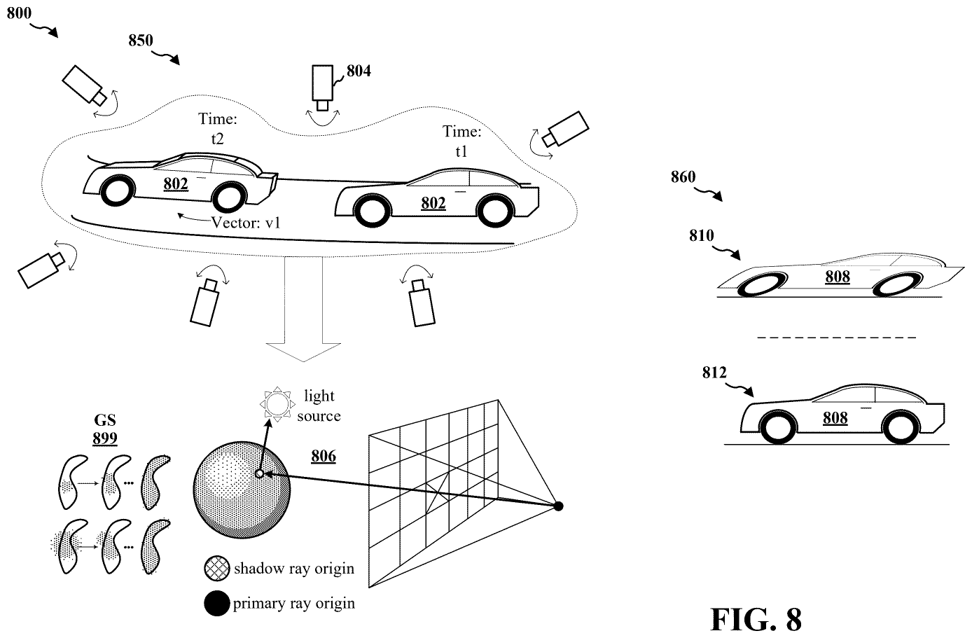

FIG. 8 illustrates a diagram 800 of an example optimization for GS ray tracing for photo-realistic simulations in accordance with one or more techniques of this disclosure. Diagram 800 shows in-time movement segmentation 850 and in-time rolling shutter optimization 860 as examples of dynamic scene optimizations for GS 899.

As noted herein, aspects enable the training of GSs using ray tracing of moving objects and sets of training images in time, unlike other example techniques. Optimizations for rolling shutter, motion blur, camera and object motion, changes in illumination, are provided by aspects herein. The GS training of moving objects may be performed incrementally and consistently in time to allow for moving object segmentation. Further, dynamic incremental quality improvement of rigid object 3DGS may be realized, according to aspects, as more frames are captured in time.

The in-time movement segmentation 850 shows, by way of example, an object 802 (e.g., a vehicle or other moving object) in time: at a time t1 and at a time t2. Images of the object 802 may be captured by a set of cameras 804 (e.g., a set of IoT cameras, such as for surveillance or other purposes). In cases where the set of cameras 804 is fixed in space and two images of the object 802 are captured in time (e.g., at t1 and t2), some examples of GS rendering may use a single GS that is consistent and optimized for of t1 and t2, resulting in a single motion vector. However, aspects herein provide for the set of cameras 804 (as fixed in space) to capture, by way of example, two sets of images of the object 802 in time (e.g., at t1 and t2) for motion and three sets of images for acceleration. Based on these five sets of images, a GS for the object may be generated that is consistent and optimized for both t1 and t2 with one motion vector. That is, aspects enable training of a 3D GS over multiple instances of time (e.g., t1 and t2, as shown by example) for ray tracing GS training 806 to learn GS parameters of the set of cameras 804 in time. Similarly, lens-specific GS parameters, and/or other types of GS parameters for aspects herein, may be trained in-time and/or for motion of objects. Accordingly, the ray tracing GS training 806 works with multiple frames in time, and moving objects provide contributions to the optimization tasks for rendering photo-realistic images. As one example, a graphics processor may be configured to generate a simulated image frame via a ray tracing operation and an additional simulated image frame via another ray tracing operation, as representations of an input image frame associated with at least one of motion or a change in time. The graphics processor may then be configured to generate an optimized simulated image frame via a further ray tracing operation, utilizing the ray tracing GS training 806 and an associated loss function that are based on the simulated image frame and the additional simulated image frame. For each of the simulated image frame and the additional simulated image frame, adjusted numbers of GS parameters of a set of GS parameters may be applied according to the loss function.

The in-time rolling shutter optimization 860 is shown for an object 808 (e.g., a car) in the context of rolling shutter failure to meet PSNR optimization criteria for rendering. Improperly trained GS parameters may lead to inaccurate modeling and result in captures for 3D GS that are distorted for the object 808, as shown for rolling shutter failure 810. However, aspects herein enable GS training, e.g., ray tracing GS training 806, with accurate multi-set modeling to capture accurate 3D GS representations of the object 808, as shown for accurate rolling shutter 812. For instance, aspects enable the rolling shutter line to be trained in time for multiple simulated image frames in time/with motion. As one example, multiple sets of images may be captured for different times/accelerations with reference to the object 808. GS training may then utilize these multiple sets of images to adjust GS parameters and generate a loss function that provides the accurate/photo-realistic rendering representation of the object 808 shown for the accurate rolling shutter 812. Aspects also include similarly applied training for motion blur and/or the like.

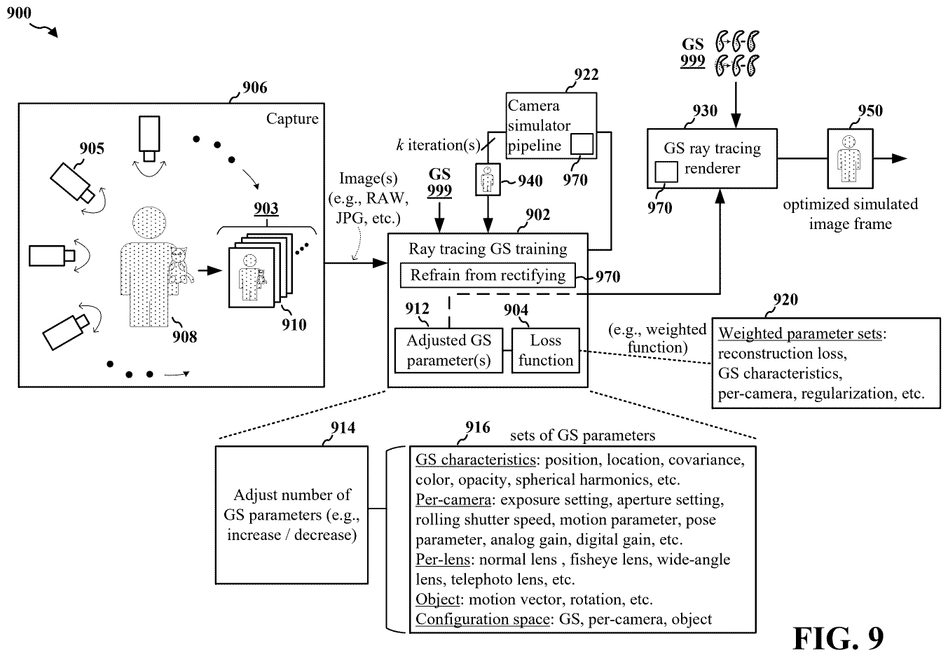

FIG. 9 illustrates a diagram 900 of ray tracing GS training for photo-realistic simulations in accordance with one or more techniques of this disclosure. Diagram 900 shows ray tracing GS training 902 and a loss function 904 (which may be an aspect of a loss function(s) described herein) utilized for application of GS 999, as described herein, in a camera simulator pipeline 922. In aspects, one or more blocks of diagram 900 may be performed by a processing unit/a graphics processor, as described herein.

The camera simulator pipeline 922 may include capturing images (e.g., use a device such as a camera/IoT camera) to capture raw input images of an object from various angles and provide constant raw photos without settings changes), may include structure from motion (SfM)/multi-view stereo (MVS) (e.g., for asset creation using the images captured and to create point cloud using a photogrammetry pipeline), may include 3D Gaussian Splatting (3DGS) (e.g., GS as described herein for 3D representations by training of 3DGS on the input images and training along with a loss function 904 comparison for the input images, may include scene clean up (e.g., the 3DGS may return a file with an entire scene (such as background and object), and may isolate the object desired for rendering and remove the rest of the scene), and may include camera simulator ray tracing (e.g., import the isolated object and follow the ray tracing pipeline for ray tracing of 3DGS with maximum intensity methods).

A set of cameras 905 may capture (at 906) a set of images 910 of an object 908, e.g., as GS asset creation, associated with an input image frame 903. In aspects, the set of cameras may include any number of cameras at various angles and/or positions relative to the object 908. In some aspects, the set of cameras may be a set of IoT cameras and/or a set of virtual cameras. Some images of the set of images 910, e.g., RAW/JPG images, may be provided to the ray tracing GS training 902, while some images of the set of images 910, e.g., RAW/JPG images, may be provided for reality capture and/or for SfM/MVS to obtain SfM parameters at the ray tracing GS training 902 as a training input(s). The ray tracing GS training 902 may also receive a simulated image frame 940 as a training input, as described herein, e.g., with respect to FIG. 5. A camera simulator pipeline 922 may be associated with generation of the simulated image frame 940, e.g., based on a first set of GS parameters. The simulated image frame 940 may be fed back to the ray tracing GS training 902, e.g., over a number k of iterations to determine if convergence is approached/met for the loss function 904. In aspects, the loss function 904 may be a weighted function associated with a set of weighting parameters 920. The set of weighting parameters 920 may include at least one of a reconstruction loss (e.g., robust distance measurement between a set of images rendered using ray-tracing and training frames, using Learned Perceptual Image Patch Similarity (LPIPS), etc.), the set of GS characteristics, the set of per camera GS parameters, a set of regularization parameters (e.g., added terms to prevent overfitting and ensure optimization converges smoothly, penalizing non-realistic camera settings, etc.), and/or the like.

The ray tracing GS training 902 may adjust (at 914) GS parameters 916 and/or numbers of parameters during a given training iteration to move toward convergence. In one example, a first set of GS parameters utilized to generate the simulated image frame 940 may be adjusted (e.g., reduced (to a subset of the first set) or increased) based on the loss function 904 to determine a second set of GS parameters utilized to generate an optimized simulated image frame 950. In aspects, GS parameters may include, without limitation, a set of GS characteristics, a set of per camera GS parameters, a set of per lens GS parameters, a set of object GS parameters, and/or the like. The set of GS characteristics may include at least one of a position, a location, a covariance, a color, an opacity, a set of spherical harmonics, etc., the set of per camera GS parameters may include at least one of an exposure setting, an aperture setting, a rolling shutter speed, a motion parameter, a pose parameter, an analog gain, a digital gain, etc., the set of per lens GS parameters may include at least one of a normal lens parameter, a fisheye lens parameter, a wide-angle lens parameter, a telephoto lens parameter, etc., and the set of object GS parameters may include at least one of a motion vector, a rotation parameter, etc. A given instance of the simulated image frame 940 may be iterated upon multiple times by the ray tracing GS training 902, which may be utilized any number of input images from the set of images 910 for each iteration. In this way, motion and changes in time of the object 908 may be utilized for the ray tracing GS training 902.

Based on a convergence of the ray tracing GS training 902, the loss function 904 may be determined in order to provide photo-realistic quality of an output, e.g., the optimized simulated image frame 950, based on adjusted GC parameters, e.g., adjusted (reduced/changed) GC parameters, lens- and/or camera-specific GC parameters, and/or the like, as described herein for aspects. The convergence of the ray tracing GS training 902, and the loss function 904, may result in a set of adjusted GC parameters 912 (e.g., a first set of GS parameters is adjusted (e.g., reduced or increased) to determine a second set of GS parameters) to be utilized by a GS ray tracing renderer 930 for rendering via ray tracing with GS 999 to generate the optimized simulated image frame 950 as output (e.g., for a memory, for additional processing, for provision to a display panel, and/or the like). In aspects, operations associated with the ray tracing GS training 902, the camera simulator pipeline 922, and/or the GS ray tracing renderer 930 may include refraining (e.g., at 970) from performing rectification.

Aspects also include optimizations for configuration space. Optimizations for configuration space may include GS parameters that define the configuration space, e.g., with multiple sets in time. Regarding configuration space, GS characteristics may include parameters for color (e.g., red (R), green (G), blue (B)), position (e.g., centroid), location (e.g., [X, Y, Z] of GS in space, a covariance matrix (e.g., 3×3) that describes shape and orientation, opacity (e.g., alpha, which may allow for translucent objects), a number of spherical harmonics, and/or the like. GS camera parameters may include parameters for exposure, aperture, rolling shutter line speed, analog gain, digital gain, pose, and/or the like. Object GS parameters may include parameters for motion vectors, rotation parameters, and/or the like.

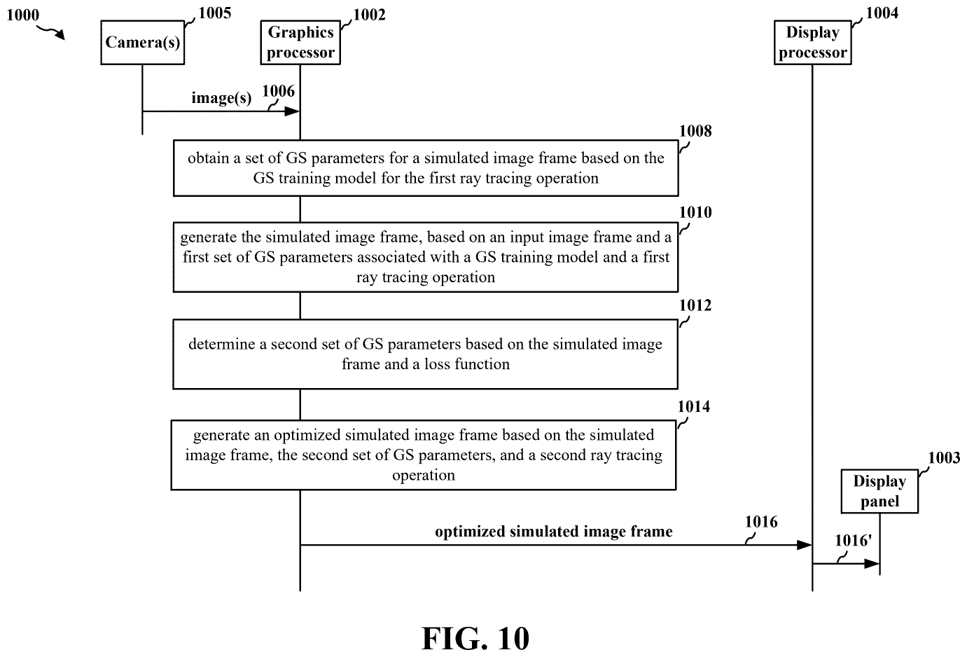

FIG. 10 is a call flow diagram 1000 for example communications between a graphics processor 1002 and a display processor 1004 in accordance with one or more techniques of this disclosure. In aspects, call flow diagram 1000 is described for GS ray tracing for photo-realistic simulations. The graphics processor 1002 may be a CPU, a GPU, and/or the like. In an example, the graphics processor 1002 may be or include the processing unit 120/the GS ray tracing trainer 198, and the display processor 1004 may be or include the display processor 127. In aspects, as shown, the graphics processor 1002 may also communicate with a set of cameras 1005 to receive a set of images 1006 associated with objects/scenes for rendering. In aspects, the graphics processor 1002 comprises a wireless communication device that is configured to perform the call flow diagram 1000.

At 1008, the graphics processor 1002 may obtain a set of GS parameters for the simulated image frame based on the GS training model for a first ray tracing operation. The set of GS parameters may include at least one of a set of GS characteristics (e.g., including a first set of GS parameters, a second set of GS parameters, an additional or third set of GS parameters, and/or the like, as described herein), a set of per camera GS parameters, a set of per lens GS parameters, a set of object GS parameters, and/or the like. In aspects, the set of GS characteristics may include at least one of a position, a location, a covariance, a color, an opacity, a set of spherical harmonics, and/or the like. In aspects, the set of per camera GS parameters may include at least one of an exposure setting, an aperture setting, a rolling shutter speed, a motion parameter, a pose parameter, an analog gain, a digital gain, and/or the like. In aspects, the set of per lens GS parameters may include at least one of a normal lens parameter, a fisheye lens parameter, a wide-angle lens parameter, a telephoto lens parameter, and/or the like. In aspects, the set of object GS parameters may include at least one of a motion vector, a rotation parameter, and/or the like.

At 1010, the graphics processor 1002 may generate a simulated image frame, as a representation of an input image frame, based on a first set of GS parameters associated with a GS training model and the first ray tracing operation (e.g., a GS ray tracing rendering(s) of the simulated image frame(s)). As one example, the input image frame may be an image(s) of the set of images 1006 captured by the set of cameras 1005. In aspects, the input image frame may include a set of raw input image frames, respectively associated with the set of cameras 1005, for an object. The graphics processor 1002 may generate the simulated image frame based on a GS ray tracing operation utilizing the first set of GS parameters, which may be determined or selected from the set of GS parameters obtained (at 806). In some aspects, the graphics processor 1002 may iteratively generate simulated image frames to reach a convergence for a loss function, as described herein. In aspects, to generate the simulated image frame, the graphics processor 1002 may generate an additional (e.g., a third, etc.) simulated image frame(s) based on the input image frame and associated with at least one of motion or a change in time.

At 1012, the graphics processor 1002 may determine a second set of GS parameters based on the simulated image frame and a loss function. In aspects, the graphics processor 1002 may be configured to adjust a number of the GS parameters of the first set of GS parameters based on the loss function associated with the GS training model to obtain the second set of GS parameters with an adjusted number of the GS parameters. In aspects, to determine the second set of GS parameters, and adjust the number of GS parameters based on the loss function, the graphics processor 1002 may reduce the first set of GS parameters, such that the adjusted number of GS parameters in the second set of GS parameters is less than the number of GS parameters in the first set of GS parameters (e.g., the second set of GS parameters may be a subset of the first set of GS parameters). In such aspects, the second set of GS parameters may include at least one less parameter associated with spherical harmonics than the first set of GS parameters. In some aspects, to determine the second set of GS parameters, the graphics processor 1002 may be configured to determine the second set of GS parameters further based on a quality improvement determination associated with the simulated image frame and a second number of GS parameters in the second set of GS parameters may be greater than a first number of GS parameters in the first set of GS parameters. For example, in some aspects, to adjust the number of GS parameters, the graphics processor 1002 may increase the number of GS parameters based on a quality improvement determination associated with simulated image frames, such that the adjusted number of GS parameters is greater than the number of GS parameters. In aspects, measurements of image quality metrics may be utilized to obtain the quality improvement determination associated with photo-realistic quality of images. In some aspects, the quality may be reduced by optimizing for fewer GS parameters to be used when rendering speed is prioritized rather than rendering quality. As one example, lower resolution images may be generated in some cases and associated quality degradation may not be visible or applicable. In such examples, reducing the number of GS parameters utilized, in order to improve speed, benefits the GS ray tracing process with negligible adverse effects. In contrast, when photo-realistic quality of images is prioritized based on applications and/or preferences, additional GS parameters may be utilized to increase image quality. Adjustments may be made based on multiple simulated image frames and/or different simulated image frames.

In aspects, the graphics processor 1002 may train the GS training model based on a set of prior simulated image frames, and may generate the loss function based on the trained GS training model. The loss function may be a ray tracing-based loss function. The set of prior simulated image frames may include the simulated image frame. The set of prior simulated image frames may be based on a camera simulation. In some aspects, to train the GS training model, the graphics processor 1002 may refrain from performing rectification in association with the second set of GS parameters. In some aspects, to train the GS training model, the graphics processor 1002 may iteratively adjust sets of GS parameters for the simulated image frame. For example, the first set of GS parameters utilized to generate a simulated image frame for a first iteration may be adjusted to determine the second set of GS parameters, the second set of GS parameters utilized to generate a second simulated image frame for a second iteration may be adjusted to determine a third set of GS parameters for a third iteration, etc., until training convergence for the loss function is reached. That is, sets of GS parameters herein may be iteratively adjusted for simulated image frames in association with ray tracing GS training. The loss function may be based on a weighted function associated with a set of weighting parameters, where the set of weighting parameters includes at least one of a reconstruction loss, the set of GS characteristics, the set of per camera GS parameters, a set of regularization parameters, and/or the like.

At 1014, the graphics processor 1002 may generate an optimized simulated image frame 1016 based on the simulated image frame, the second set of GS parameters, and a second ray tracing operation. The optimized simulated image frame 1016 may be based on a GS operation associated with the second ray tracing operation (e.g., a GS ray tracing rendering(s) of the optimized simulated image frame 1016) and representative of the object in association with the input image frame. In aspects, to generate the optimized simulated image frame 1016, the processor is further configured to generate the optimized simulated image frame 1016 also based on the additional or third simulated image frame(s), an additional or third adjusted number of GS parameters for a third set of GS parameters associated with the set of GS parameters associated with the additional or third simulated image frame(s), and a third ray tracing operation (e.g., a GS ray tracing rendering(s) of the additional or third simulated image frame(s)). In aspects, the additional or third set of GS parameters may be based on the loss function. The optimized simulated image frame 1016 may be based on a first GS operation having a first number of GS parameters based on the GS training model and a second GS operation having a second number of GS parameters based on the GS training model. In aspects, to generate the optimized simulated image frame 1016, the graphics processor 1002 may refrain from performing rectification in association with the adjusted number of GS parameters.

The graphics processor 1002 may output the optimized simulated image frame 1016. As one example, the graphics processor 1002 may provide the optimized simulated image frame 1016 for a display panel 1003. In aspects, the optimized simulated image frame 1016 may be provided for the display panel 1003 via a display processor 1004 configured to process the optimized simulated image frame 1016 and provide a processed representation 1016′ of the optimized simulated image frame 1016 to the display panel 1003. In some aspects, the display panel 1003 may be, without limitation, a head mounted device (HMD) or the like (e.g., for an application such as a virtual reality (VR)/extended reality (XR) application), a desktop/laptop monitor, a display screen of a wireless communication device, and/or the like. As one example, the graphics processor 1002 may, additionally or alternatively, store the optimized simulated image frame 1016 in a memory, such as a memory associated with the graphics processor 1002 and/or the display processor 1004.

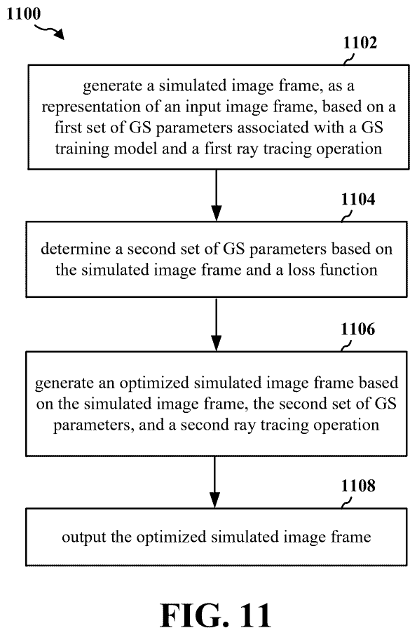

FIG. 11 is a flowchart 1100 of an example method of graphics processing in accordance with one or more techniques of this disclosure. The method may be for Gaussian splatting ray tracing for photo-realistic simulations. The method may be performed by an apparatus, such as an apparatus for graphics processing, a GPU, a CPU, a wireless communication device, and the like, as used in connection with the aspects of FIGS. 1-9.

At 1102, the apparatus may generate a simulated image frame, as a representation of an input image frame, based on a first set of GS parameters associated with a GS training model and a first ray tracing operation. For example, referring to FIG. 10, the graphics processor 1002 may obtain (at 1008) a set of GS parameters (e.g., 760, 770 in FIG. 7; 916 in FIG. 9) for the simulated image frame (e.g., 640 in FIG. 6; 940 in FIG. 9) based on the GS training model (e.g., 602, 699 in FIG. 6; 902, 999 in FIG. 9) for a first ray tracing operation (e.g., 622 in FIG. 6; 922 in FIG. 9). The set of GS parameters (e.g., 760, 770 in FIG. 7; 916 in FIG. 9) may include at least one of a set of GS characteristics (e.g., including a first set of GS parameters, a second set of GS parameters, an additional or third set of GS parameters, and/or the like, as described herein), a set of per camera GS parameters (e.g., 850, 812, 860 in FIG. 8), a set of per lens GS parameters, a set of object GS parameters, and/or the like. In aspects, the set of GS characteristics may include at least one of a position, a location, a covariance, a color, an opacity, a set of spherical harmonics (e.g., 760 in FIG. 7), and/or the like. In aspects, the set of per camera GS parameters may include at least one of an exposure setting, an aperture setting, a rolling shutter speed (e.g., 812, 860 in FIG. 8), a motion parameter (e.g., 850 in FIG. 8), a pose parameter, an analog gain, a digital gain, and/or the like. In aspects, the set of per lens GS parameters may include at least one of a normal lens parameter, a fisheye lens parameter, a wide-angle lens parameter, a telephoto lens parameter, and/or the like. In aspects, the set of object GS parameters may include at least one of a motion vector, a rotation parameter, and/or the like.

The graphics processor 1002 may generate (at 1010) a simulated image frame (e.g., 640 in FIG. 6; 940 in FIG. 9), as a representation of an input image frame (e.g., 603 in FIG. 6; 903 in FIG. 9), based on a first set of GS parameters (e.g., 760, 770 in FIG. 7; 916 in FIG. 9) associated with a GS training model (e.g., 602, 699 in FIG. 6; 902, 999 in FIG. 9) and the first ray tracing operation (e.g., 622 in FIG. 6; 922 in FIG. 9) (e.g., a GS ray tracing rendering(s) of the simulated image frame(s) (e.g., 640 in FIG. 6; 940 in FIG. 9)). As one example, the input image frame (e.g., 603 in FIG. 6; 903 in FIG. 9) may be an image(s) of the set of images 1006 (e.g., 610 in FIG. 6; 910 in FIG. 9) captured (e.g., at 606 in FIG. 6; at 906 in FIG. 9) by the set of cameras 1005 (e.g., 605 in FIG. 6; 804 in FIG. 8; 905 in FIG. 9). In aspects, the input image frame (e.g., 603 in FIG. 6; 903 in FIG. 9) may include a set of raw input image frames (e.g., 603 in FIG. 6; 903 in FIG. 9), respectively associated with the set of cameras 1005 (e.g., 605 in FIG. 6; 804 in FIG. 8; 905 in FIG. 9), for an object (e.g., 608 in FIG. 6; 802, 808 in FIG. 8; 908 in FIG. 9). The graphics processor 1002 may generate the simulated image frame (e.g., 640 in FIG. 6; 940 in FIG. 9) based on a GS ray tracing operation (e.g., 622 in FIG. 6; 922 in FIG. 9) utilizing the first set of GS parameters (e.g., 760, 770 in FIG. 7; 916 in FIG. 9), which may be determined or selected from the set of GS parameters (e.g., 760, 770 in FIG. 7; 916 in FIG. 9) obtained (at 1008). In some aspects, the graphics processor 1002 may iteratively (e.g., k iterations in FIGS. 6, 9) generate simulated image frames (e.g., 640 in FIG. 6; 940 in FIG. 9) to reach a convergence for a loss function (e.g., 604 in FIG. 6; 904 in FIG. 9), as described herein. In aspects, to generate the simulated image frame (e.g., 640 in FIG. 6; 940 in FIG. 9), the graphics processor 1002 may generate an additional (e.g., a third, etc.) simulated image frame(s) (e.g., 640 in FIG. 6; 940 in FIG. 9) based on the input image frame (e.g., 603 in FIG. 6; 903 in FIG. 9) and associated with at least one of motion (e.g., v1 in FIG. 8) or a change in time (e.g., t1, t2 in FIG. 8).

At 1104, the apparatus may determine a second set of GS parameters based on the simulated image frame and a loss function. For example, referring to FIG. 10, the graphics processor 1002 may determine a second set of GS parameters (e.g., 760, 770 in FIG. 7; 916 in FIG. 9) based on the simulated image frame (e.g., 640 in FIG. 6; 940 in FIG. 9) and a loss function (e.g., 604 in FIG. 6; 904 in FIG. 9). In aspects, the graphics processor 1002 may be configured to adjust (e.g., 912, 914 in FIG. 9) a number of the GS parameters of the first set of GS parameters (e.g., 760, 770 in FIG. 7; 916 in FIG. 9) based on the loss function (e.g., 604 in FIG. 6; 904 in FIG. 9) associated with the GS training model (e.g., 602, 699 in FIG. 6; 902, 999 in FIG. 9) to obtain the second set of GS parameters (e.g., 760, 770 in FIG. 7; 916 in FIG. 9) with an adjusted (e.g., 912, 914 in FIG. 9) number of the GS parameters. In aspects, to determine the second set of GS parameters (e.g., 760, 770 in FIG. 7; 916 in FIG. 9), and adjust (e.g., 912, 914 in FIG. 9) the number of GS parameters based on the loss function (e.g., 604 in FIG. 6; 904 in FIG. 9), the graphics processor 1002 may reduce the first set of GS parameters (e.g., 760, 770 in FIG. 7; 916 in FIG. 9), such that the adjusted (e.g., 912, 914 in FIG. 9) number of GS parameters in the second set of GS parameters (e.g., 760, 770 in FIG. 7; 916 in FIG. 9) is less than the number of GS parameters in the first set of GS parameters (e.g., 760, 770 in FIG. 7; 916 in FIG. 9) (e.g., the second set of GS parameters may be a subset of the first set of GS parameters (e.g., 760, 770 in FIG. 7; 916 in FIG. 9)). In such aspects, the second set of GS parameters (e.g., 760, 770 in FIG. 7; 916 in FIG. 9) may include at least one less parameter associated with spherical harmonics (e.g., 760 in FIG. 7) than the first set of GS parameters (e.g., 760, 770 in FIG. 7; 916 in FIG. 9). In some aspects, to determine the second set of GS parameters (e.g., 760, 770 in FIG. 7; 916 in FIG. 9), the graphics processor 1002 may be configured to determine the second set of GS parameters (e.g., 760, 770 in FIG. 7; 916 in FIG. 9) further based on a quality improvement determination associated with the simulated image frame (e.g., 640 in FIG. 6; 940 in FIG. 9) and a second number of GS parameters in the second set of GS parameters (e.g., 760, 770 in FIG. 7; 916 in FIG. 9) may be greater than a first number of GS parameters in the first set of GS parameters (e.g., 760, 770 in FIG. 7; 916 in FIG. 9). For example, in some aspects, to adjust (e.g., 912, 914 in FIG. 9) the number of GS parameters, the graphics processor 1002 may increase the number of GS parameters based on a quality improvement determination associated with simulated image frames (e.g., 640 in FIG. 6; 940 in FIG. 9), such that the adjusted (e.g., 912, 914 in FIG. 9) number of GS parameters is greater than the number of GS parameters. In aspects, measurements of image quality metrics may be utilized to obtain the quality improvement determination associated with photo-realistic quality of images. In some aspects, the quality may be reduced by optimizing for fewer GS parameters to be used when rendering speed is prioritized rather than rendering quality. As one example, lower resolution images may be generated in some cases and associated quality degradation may not be visible or applicable. In such examples, reducing the number of GS parameters utilized, in order to improve speed, benefits the GS ray tracing process with negligible adverse effects. In contrast, when photo-realistic quality of images is prioritized based on applications and/or preferences, additional GS parameters may be utilized to increase image quality. Adjustments (e.g., 912, 914 in FIG. 9) may be made based on multiple simulated image frames (e.g., 640 in FIG. 6; 940 in FIG. 9) and/or different simulated image frames (e.g., 640 in FIG. 6; 940 in FIG. 9).

In aspects, the graphics processor 1002 may train the GS training model (e.g., 602, 699 in FIG. 6; 902, 999 in FIG. 9) based on a set of prior simulated image frames, and may generate the loss function (e.g., 604 in FIG. 6; 904 in FIG. 9) based on the trained GS training model (e.g., 602, 699 in FIG. 6; 902, 999 in FIG. 9). The loss function (e.g., 604 in FIG. 6; 904 in FIG. 9) may be a ray tracing-based loss function (e.g., 604 in FIG. 6; 904 in FIG. 9). The set of prior simulated image frames may include the simulated image frame (e.g., 640 in FIG. 6; 940 in FIG. 9). The set of prior simulated image frames may be based on a camera simulation (e.g., 622 in FIG. 6; 922 in FIG. 9). In some aspects, to train the GS training model (e.g., 602, 699 in FIG. 6; 902, 999 in FIG. 9), the graphics processor 1002 may refrain (e.g., at 970 in FIG. 9) from performing rectification in association with the second set of GS parameters (e.g., 760, 770 in FIG. 7; 916 in FIG. 9). In some aspects, to train the GS training model (e.g., 602, 699 in FIG. 6; 902, 999 in FIG. 9), the graphics processor 1002 may iteratively (e.g., k iterations in FIGS. 6, 9) adjust (e.g., 912, 914 in FIG. 9) sets of GS parameters (e.g., 760, 770 in FIG. 7; 916 in FIG. 9) for the simulated image frame (e.g., 640 in FIG. 6; 940 in FIG. 9). For example, the first set of GS parameters (e.g., 760, 770 in FIG. 7; 916 in FIG. 9) utilized to generate a simulated image frame (e.g., 640 in FIG. 6; 940 in FIG. 9) for a first iteration may be adjusted (e.g., 912, 914 in FIG. 9) to determine the second set of GS parameters (e.g., 760, 770 in FIG. 7; 916 in FIG. 9), the second set of GS parameters (e.g., 760, 770 in FIG. 7; 916 in FIG. 9) utilized to generate a second simulated image frame (e.g., 640 in FIG. 6; 940 in FIG. 9) for a second iteration may be adjusted (e.g., 912, 914 in FIG. 9) to determine a third set of GS parameters (e.g., 760, 770 in FIG. 7; 916 in FIG. 9) for a third iteration, etc., until training convergence for the loss function (e.g., 604 in FIG. 6; 904 in FIG. 9) is reached. That is, sets of GS parameters herein may be iteratively (e.g., k iterations in FIGS. 6, 9) adjusted (e.g., 912, 914 in FIG. 9) for simulated image frames (e.g., 640 in FIG. 6; 940 in FIG. 9) in association with ray tracing GS training (e.g., 602, 699 in FIG. 6; 902, 999 in FIG. 9). The loss function (e.g., 604 in FIG. 6; 904 in FIG. 9) may be based on a weighted function associated with a set of weighting parameters (e.g., 920 in FIG. 9), where the set of weighting parameters (e.g., 920 in FIG. 9) includes at least one of a reconstruction loss, the set of GS characteristics, the set of per camera GS parameters (e.g., 850, 812, 860 in FIG. 8), a set of regularization parameters, and/or the like.

At 1106, the apparatus may generate an optimized simulated image frame based on the simulated image frame, the second set of GS parameters, and a second ray tracing operation. For example, referring to FIG. 10, at 1014, the graphics processor 1002 may generate an optimized simulated image frame 1016 (e.g., 650 in FIG. 6; 950 in FIG. 9) based on the simulated image frame (e.g., 640 in FIG. 6; 940 in FIG. 9), the second set of GS parameters (e.g., 760, 770 in FIG. 7; 916 in FIG. 9), and a second ray tracing operation (e.g., 630, 632, 634, 638 in FIG. 6; 930 in FIG. 9). The optimized simulated image frame 1016 (e.g., 650 in FIG. 6; 950 in FIG. 9) may be based on a GS operation (e.g., 699 in FIG. 6; 899 in FIG. 8; 999 in FIG. 9) associated with the second ray tracing operation (e.g., 630, 632, 634, 638 in FIG. 6; 930 in FIG. 9) (e.g., a GS ray tracing rendering(s) of the optimized simulated image frame 1016 (e.g., 650 in FIG. 6; 950 in FIG. 9)) and representative of the object (e.g., 608 in FIG. 6; 802, 808 in FIG. 8; 908 in FIG. 9) in association with the input image frame (e.g., 603 in FIG. 6; 903 in FIG. 9). In aspects, to generate the optimized simulated image frame 1016 (e.g., 650 in FIG. 6; 950 in FIG. 9), the processor is further configured to generate the optimized simulated image frame 1016 (e.g., 650 in FIG. 6; 950 in FIG. 9) also based on the additional or third simulated image frame(s) (e.g., 640 in FIG. 6; 940 in FIG. 9), an additional or third adjusted (e.g., 912, 914 in FIG. 9) number of GS parameters for a third set of GS parameters (e.g., 760, 770 in FIG. 7; 916 in FIG. 9) associated with the set of GS parameters (e.g., 760, 770 in FIG. 7; 916 in FIG. 9) associated with the additional or third simulated image frame(s) (e.g., 640 in FIG. 6; 940 in FIG. 9), and a third ray tracing operation (e.g., 622 in FIG. 6; 922 in FIG. 9) (e.g., a GS ray tracing rendering(s) of the additional or third simulated image frame(s) (e.g., 640 in FIG. 6; 940 in FIG. 9)). In aspects, the additional or third set of GS parameters may be based on the loss function (e.g., 604 in FIG. 6; 904 in FIG. 9). The optimized simulated image frame 1016 (e.g., 650 in FIG. 6; 950 in FIG. 9) may be based on a first GS operation (e.g., 699 in FIG. 6; 899 in FIG. 8; 999 in FIG. 9) having a first number of GS parameters based on the GS training model (e.g., 602, 699 in FIG. 6; 902, 999 in FIG. 9) and a second GS operation (e.g., 699 in FIG. 6; 899 in FIG. 8; 999 in FIG. 9) having a second number of GS parameters based on the GS training model (e.g., 602, 699 in FIG. 6; 902, 999 in FIG. 9). In aspects, to generate the optimized simulated image frame 1016 (e.g., 650 in FIG. 6; 950 in FIG. 9), the graphics processor 1002 may refrain (e.g., at 970 in FIG. 9) from performing rectification in association with the adjusted (e.g., 912, 914 in FIG. 9) number of GS parameters.

At 1108, the apparatus may output the optimized simulated image frame. For example, referring to FIG. 10, the graphics processor 1002 may output the optimized simulated image frame 1016 (e.g., 650 in FIG. 6; 950 in FIG. 9). As one example, the graphics processor 1002 may provide the optimized simulated image frame 1016 (e.g., 650 in FIG. 6; 950 in FIG. 9) for a display panel 1003. In aspects, the optimized simulated image frame 1016 (e.g., 650 in FIG. 6; 950 in FIG. 9) may be provided for the display panel 1003 via a display processor 1004 configured to process the optimized simulated image frame 1016 (e.g., 650 in FIG. 6; 950 in FIG. 9) and provide a processed representation 1016′ of the optimized simulated image frame 1016 (e.g., 650 in FIG. 6; 950 in FIG. 9) to the display panel 1003. In some aspects, the display panel 1003 may be, without limitation, a head mounted device (HMD) or the like (e.g., for an application such as a virtual reality (VR)/extended reality (XR) application), a desktop/laptop monitor, a display screen of a wireless communication device, and/or the like. As one example, the graphics processor 1002 may, additionally or alternatively, store the optimized simulated image frame 1016 (e.g., 650 in FIG. 6; 950 in FIG. 9) in a memory, such as a memory associated with the graphics processor 1002 and/or the display processor 1004, as described herein.

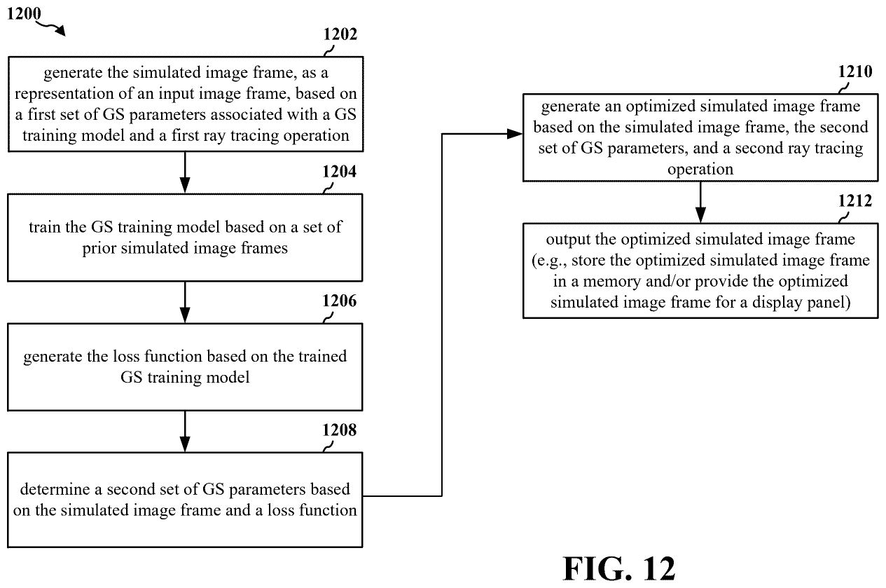

FIG. 12 is a flowchart 1200 of an example method of graphics processing in accordance with one or more techniques of this disclosure. The method may be for Gaussian splatting ray tracing for photo-realistic simulations. The method may be performed by an apparatus, such as an apparatus for graphics processing, a GPU, a CPU, a wireless communication device, and the like, as used in connection with the aspects of FIGS. 1-9.

At 1202, the apparatus may generate the simulated image frame, as a representation of an input image frame, based on a first set of GS parameters associated with a GS training model and a first ray tracing operation. For example, referring to FIG. 10, the graphics processor 1002 may obtain (at 1008) a set of GS parameters (e.g., 760, 770 in FIG. 7; 916 in FIG. 9) for the simulated image frame (e.g., 640 in FIG. 6; 940 in FIG. 9) based on the GS training model (e.g., 602, 699 in FIG. 6; 902, 999 in FIG. 9) for a first ray tracing operation (e.g., 622 in FIG. 6; 922 in FIG. 9). The set of GS parameters (e.g., 760, 770 in FIG. 7; 916 in FIG. 9) may include at least one of a set of GS characteristics (e.g., including a first set of GS parameters, a second set of GS parameters, an additional or third set of GS parameters, and/or the like, as described herein), a set of per camera GS parameters (e.g., 850, 812, 860 in FIG. 8), a set of per lens GS parameters, a set of object GS parameters, and/or the like. In aspects, the set of GS characteristics may include at least one of a position, a location, a covariance, a color, an opacity, a set of spherical harmonics (e.g., 760 in FIG. 7), and/or the like. In aspects, the set of per camera GS parameters may include at least one of an exposure setting, an aperture setting, a rolling shutter speed (e.g., 812, 860 in FIG. 8), a motion parameter (e.g., 850 in FIG. 8), a pose parameter, an analog gain, a digital gain, and/or the like. In aspects, the set of per lens GS parameters may include at least one of a normal lens parameter, a fisheye lens parameter, a wide-angle lens parameter, a telephoto lens parameter, and/or the like. In aspects, the set of object GS parameters may include at least one of a motion vector, a rotation parameter, and/or the like.

The graphics processor 1002 may generate (at 1010) a simulated image frame (e.g., 640 in FIG. 6; 940 in FIG. 9), as a representation of an input image frame (e.g., 603 in FIG. 6; 903 in FIG. 9), based on a first set of GS parameters (e.g., 760, 770 in FIG. 7; 916 in FIG. 9) associated with a GS training model (e.g., 602, 699 in FIG. 6; 902, 999 in FIG. 9) and the first ray tracing operation (e.g., 622 in FIG. 6; 922 in FIG. 9) (e.g., a GS ray tracing rendering(s) of the simulated image frame(s) (e.g., 640 in FIG. 6; 940 in FIG. 9)). As one example, the input image frame (e.g., 603 in FIG. 6; 903 in FIG. 9) may be an image(s) of the set of images 1006 (e.g., 610 in FIG. 6; 910 in FIG. 9) captured (e.g., at 606 in FIG. 6; at 906 in FIG. 9) by the set of cameras 1005 (e.g., 605 in FIG. 6; 804 in FIG. 8; 905 in FIG. 9). In aspects, the input image frame (e.g., 603 in FIG. 6; 903 in FIG. 9) may include a set of raw input image frames (e.g., 603 in FIG. 6; 903 in FIG. 9), respectively associated with the set of cameras 1005 (e.g., 605 in FIG. 6; 804 in FIG. 8; 905 in FIG. 9), for an object (e.g., 608 in FIG. 6; 802, 808 in FIG. 8; 908 in FIG. 9). The graphics processor 1002 may generate the simulated image frame (e.g., 640 in FIG. 6; 940 in FIG. 9) based on a GS ray tracing operation (e.g., 622 in FIG. 6; 922 in FIG. 9) utilizing the first set of GS parameters (e.g., 760, 770 in FIG. 7; 916 in FIG. 9), which may be determined or selected from the set of GS parameters (e.g., 760, 770 in FIG. 7; 916 in FIG. 9) obtained (at 1008). In some aspects, the graphics processor 1002 may iteratively (e.g., k iterations in FIGS. 6, 9) generate simulated image frames (e.g., 640 in FIG. 6; 940 in FIG. 9) to reach a convergence for a loss function (e.g., 604 in FIG. 6; 904 in FIG. 9), as described herein. In aspects, to generate the simulated image frame (e.g., 640 in FIG. 6; 940 in FIG. 9), the graphics processor 1002 may generate an additional (e.g., a third, etc.) simulated image frame(s) (e.g., 640 in FIG. 6; 940 in FIG. 9) based on the input image frame (e.g., 603 in FIG. 6; 903 in FIG. 9) and associated with at least one of motion (e.g., v1 in FIG. 8) or a change in time (e.g., t1, t2 in FIG. 8).

At 1204, the apparatus may train the GS training model based on a set of prior simulated image frames. For example, referring to FIG. 10, the graphics processor 1002 may train the GS training model (e.g., 602, 699 in FIG. 6; 902, 999 in FIG. 9) based on a set of prior simulated image frames, and may generate the loss function (e.g., 604 in FIG. 6; 904 in FIG. 9) based on the trained GS training model (e.g., 602, 699 in FIG. 6; 902, 999 in FIG. 9). The loss function (e.g., 604 in FIG. 6; 904 in FIG. 9) may be a ray tracing-based loss function (e.g., 604 in FIG. 6; 904 in FIG. 9). The set of prior simulated image frames may include the simulated image frame (e.g., 640 in FIG. 6; 940 in FIG. 9). The set of prior simulated image frames may be based on a camera simulation (e.g., 622 in FIG. 6; 922 in FIG. 9). In some aspects, to train the GS training model (e.g., 602, 699 in FIG. 6; 902, 999 in FIG. 9), the graphics processor 1002 may refrain (e.g., at 970 in FIG. 9) from performing rectification in association with the second set of GS parameters (e.g., 760, 770 in FIG. 7; 916 in FIG. 9). In some aspects, to train the GS training model (e.g., 602, 699 in FIG. 6; 902, 999 in FIG. 9), the graphics processor 1002 may iteratively (e.g., k iterations in FIGS. 6, 9) adjust (e.g., 912, 914 in FIG. 9) sets of GS parameters (e.g., 760, 770 in FIG. 7; 916 in FIG. 9) for the simulated image frame (e.g., 640 in FIG. 6; 940 in FIG. 9). For example, the first set of GS parameters (e.g., 760, 770 in FIG. 7; 916 in FIG. 9) utilized to generate a simulated image frame (e.g., 640 in FIG. 6; 940 in FIG. 9) for a first iteration may be adjusted (e.g., 912, 914 in FIG. 9) to determine the second set of GS parameters (e.g., 760, 770 in FIG. 7; 916 in FIG. 9), the second set of GS parameters (e.g., 760, 770 in FIG. 7; 916 in FIG. 9) utilized to generate a second simulated image frame (e.g., 640 in FIG. 6; 940 in FIG. 9) for a second iteration may be adjusted (e.g., 912, 914 in FIG. 9) to determine a third set of GS parameters (e.g., 760, 770 in FIG. 7; 916 in FIG. 9) for a third iteration, etc., until training convergence for the loss function (e.g., 604 in FIG. 6; 904 in FIG. 9) is reached. That is, sets of GS parameters herein may be iteratively (e.g., k iterations in FIGS. 6, 9) adjusted (e.g., 912, 914 in FIG. 9) for simulated image frames (e.g., 640 in FIG. 6; 940 in FIG. 9) in association with ray tracing GS training (e.g., 602, 699 in FIG. 6; 902, 999 in FIG. 9). The loss function (e.g., 604 in FIG. 6; 904 in FIG. 9) may be based on a weighted function associated with a set of weighting parameters (e.g., 920 in FIG. 9), where the set of weighting parameters (e.g., 920 in FIG. 9) includes at least one of a reconstruction loss, the set of GS characteristics, the set of per camera GS parameters (e.g., 850, 812, 860 in FIG. 8), a set of regularization parameters, and/or the like.

At 1206, the apparatus may generate the loss function based on the trained GS training model. For example, referring to FIG. 10, the graphics processor 1002 may train the GS training model (e.g., 602, 699 in FIG. 6; 902, 999 in FIG. 9) based on a set of prior simulated image frames, and may generate the loss function (e.g., 604 in FIG. 6; 904 in FIG. 9) based on the trained GS training model (e.g., 602, 699 in FIG. 6; 902, 999 in FIG. 9). The loss function (e.g., 604 in FIG. 6; 904 in FIG. 9) may be a ray tracing-based loss function (e.g., 604 in FIG. 6; 904 in FIG. 9). The set of prior simulated image frames may include the simulated image frame (e.g., 640 in FIG. 6; 940 in FIG. 9). The set of prior simulated image frames may be based on a camera simulation (e.g., 622 in FIG. 6; 922 in FIG. 9). In some aspects, to train the GS training model (e.g., 602, 699 in FIG. 6; 902, 999 in FIG. 9), the graphics processor 1002 may refrain (e.g., at 970 in FIG. 9) from performing rectification in association with the second set of GS parameters (e.g., 760, 770 in FIG. 7; 916 in FIG. 9). In some aspects, to train the GS training model (e.g., 602, 699 in FIG. 6; 902, 999 in FIG. 9), the graphics processor 1002 may iteratively (e.g., k iterations in FIGS. 6, 9) adjust (e.g., 912, 914 in FIG. 9) sets of GS parameters (e.g., 760, 770 in FIG. 7; 916 in FIG. 9) for the simulated image frame (e.g., 640 in FIG. 6; 940 in FIG. 9). For example, the first set of GS parameters (e.g., 760, 770 in FIG. 7; 916 in FIG. 9) utilized to generate a simulated image frame (e.g., 640 in FIG. 6; 940 in FIG. 9) for a first iteration may be adjusted (e.g., 912, 914 in FIG. 9) to determine the second set of GS parameters (e.g., 760, 770 in FIG. 7; 916 in FIG. 9), the second set of GS parameters (e.g., 760, 770 in FIG. 7; 916 in FIG. 9) utilized to generate a second simulated image frame (e.g., 640 in FIG. 6; 940 in FIG. 9) for a second iteration may be adjusted (e.g., 912, 914 in FIG. 9) to determine a third set of GS parameters (e.g., 760, 770 in FIG. 7; 916 in FIG. 9) for a third iteration, etc., until training convergence for the loss function (e.g., 604 in FIG. 6; 904 in FIG. 9) is reached. That is, sets of GS parameters herein may be iteratively (e.g., k iterations in FIGS. 6, 9) adjusted (e.g., 912, 914 in FIG. 9) for simulated image frames (e.g., 640 in FIG. 6; 940 in FIG. 9) in association with ray tracing GS training (e.g., 602, 699 in FIG. 6; 902, 999 in FIG. 9). The loss function (e.g., 604 in FIG. 6; 904 in FIG. 9) may be based on a weighted function associated with a set of weighting parameters (e.g., 920 in FIG. 9), where the set of weighting parameters (e.g., 920 in FIG. 9) includes at least one of a reconstruction loss, the set of GS characteristics, the set of per camera GS parameters (e.g., 850, 812, 860 in FIG. 8), a set of regularization parameters, and/or the like.

At 1208, the apparatus may determine a second set of GS parameters based on the simulated image frame and a loss function. For example, referring to FIG. 10, the graphics processor 1002 may determine a second set of GS parameters (e.g., 760, 770 in FIG. 7; 916 in FIG. 9) based on the simulated image frame (e.g., 640 in FIG. 6; 940 in FIG. 9) and a loss function (e.g., 604 in FIG. 6; 904 in FIG. 9). In aspects, the graphics processor 1002 may be configured to adjust (e.g., 912, 914 in FIG. 9) a number of the GS parameters of the first set of GS parameters (e.g., 760, 770 in FIG. 7; 916 in FIG. 9) based on the loss function (e.g., 604 in FIG. 6; 904 in FIG. 9) associated with the GS training model (e.g., 602, 699 in FIG. 6; 902, 999 in FIG. 9) to obtain the second set of GS parameters (e.g., 760, 770 in FIG. 7; 916 in FIG. 9) with an adjusted (e.g., 912, 914 in FIG. 9) number of the GS parameters. In aspects, to determine the second set of GS parameters (e.g., 760, 770 in FIG. 7; 916 in FIG. 9), and adjust (e.g., 912, 914 in FIG. 9) the number of GS parameters based on the loss function (e.g., 604 in FIG. 6; 904 in FIG. 9), the graphics processor 1002 may reduce the first set of GS parameters (e.g., 760, 770 in FIG. 7; 916 in FIG. 9), such that the adjusted (e.g., 912, 914 in FIG. 9) number of GS parameters in the second set of GS parameters (e.g., 760, 770 in FIG. 7; 916 in FIG. 9) is less than the number of GS parameters in the first set of GS parameters (e.g., 760, 770 in FIG. 7; 916 in FIG. 9) (e.g., the second set of GS parameters may be a subset of the first set of GS parameters (e.g., 760, 770 in FIG. 7; 916 in FIG. 9)). In such aspects, the second set of GS parameters (e.g., 760, 770 in FIG. 7; 916 in FIG. 9) may include at least one less parameter associated with spherical harmonics (e.g., 760 in FIG. 7) than the first set of GS parameters (e.g., 760, 770 in FIG. 7; 916 in FIG. 9). In some aspects, to determine the second set of GS parameters (e.g., 760, 770 in FIG. 7; 916 in FIG. 9), the graphics processor 1002 may be configured to determine the second set of GS parameters (e.g., 760, 770 in FIG. 7; 916 in FIG. 9) further based on a quality improvement determination associated with the simulated image frame (e.g., 640 in FIG. 6; 940 in FIG. 9) and a second number of GS parameters in the second set of GS parameters (e.g., 760, 770 in FIG. 7; 916 in FIG. 9) may be greater than a first number of GS parameters in the first set of GS parameters (e.g., 760, 770 in FIG. 7; 916 in FIG. 9). For example, in some aspects, to adjust (e.g., 912, 914 in FIG. 9) the number of GS parameters, the graphics processor 1002 may increase the number of GS parameters based on a quality improvement determination associated with simulated image frames (e.g., 640 in FIG. 6; 940 in FIG. 9), such that the adjusted (e.g., 912, 914 in FIG. 9) number of GS parameters is greater than the number of GS parameters. In aspects, measurements of image quality metrics may be utilized to obtain the quality improvement determination associated with photo-realistic quality of images. In some aspects, the quality may be reduced by optimizing for fewer GS parameters to be used when rendering speed is prioritized rather than rendering quality. As one example, lower resolution images may be generated in some cases and associated quality degradation may not be visible or applicable. In such examples, reducing the number of GS parameters utilized, in order to improve speed, benefits the GS ray tracing process with negligible adverse effects. In contrast, when photo-realistic quality of images is prioritized based on applications and/or preferences, additional GS parameters may be utilized to increase image quality. Adjustments (e.g., 912, 914 in FIG. 9) may be made based on multiple simulated image frames (e.g., 640 in FIG. 6; 940 in FIG. 9) and/or different simulated image frames (e.g., 640 in FIG. 6; 940 in FIG. 9).

At 1210, the apparatus may generate an optimized simulated image frame based on the simulated image frame, the second set of GS parameters, and a second ray tracing operation. For example, referring to FIG. 10, at 1014, the graphics processor 1002 may generate an optimized simulated image frame 1016 (e.g., 650 in FIG. 6; 950 in FIG. 9) based on the simulated image frame (e.g., 640 in FIG. 6; 940 in FIG. 9), the second set of GS parameters (e.g., 760, 770 in FIG. 7; 916 in FIG. 9), and a second ray tracing operation (e.g., 630, 632, 634, 638 in FIG. 6; 930 in FIG. 9). The optimized simulated image frame 1016 (e.g., 650 in FIG. 6; 950 in FIG. 9) may be based on a GS operation (e.g., 699 in FIG. 6; 899 in FIG. 8; 999 in FIG. 9) associated with the second ray tracing operation (e.g., 630, 632, 634, 638 in FIG. 6; 930 in FIG. 9) (e.g., a GS ray tracing rendering(s) of the optimized simulated image frame 1016 (e.g., 650 in FIG. 6; 950 in FIG. 9)) and representative of the object (e.g., 608 in FIG. 6; 802, 808 in FIG. 8; 908 in FIG. 9) in association with the input image frame (e.g., 603 in FIG. 6; 903 in FIG. 9). In aspects, to generate the optimized simulated image frame 1016 (e.g., 650 in FIG. 6; 950 in FIG. 9), the processor is further configured to generate the optimized simulated image frame 1016 (e.g., 650 in FIG. 6; 950 in FIG. 9) also based on the additional or third simulated image frame(s) (e.g., 640 in FIG. 6; 940 in FIG. 9), an additional or third adjusted (e.g., 912, 914 in FIG. 9) number of GS parameters for a third set of GS parameters (e.g., 760, 770 in FIG. 7; 916 in FIG. 9) associated with the set of GS parameters (e.g., 760, 770 in FIG. 7; 916 in FIG. 9) associated with the additional or third simulated image frame(s) (e.g., 640 in FIG. 6; 940 in FIG. 9), and a third ray tracing operation (e.g., 622 in FIG. 6; 922 in FIG. 9) (e.g., a GS ray tracing rendering(s) of the additional or third simulated image frame(s) (e.g., 640 in FIG. 6; 940 in FIG. 9)). In aspects, the additional or third set of GS parameters may be based on the loss function (e.g., 604 in FIG. 6; 904 in FIG. 9). The optimized simulated image frame 1016 (e.g., 650 in FIG. 6; 950 in FIG. 9) may be based on a first GS operation (e.g., 699 in FIG. 6; 899 in FIG. 8; 999 in FIG. 9) having a first number of GS parameters based on the GS training model (e.g., 602, 699 in FIG. 6; 902, 999 in FIG. 9) and a second GS operation (e.g., 699 in FIG. 6; 899 in FIG. 8; 999 in FIG. 9) having a second number of GS parameters based on the GS training model (e.g., 602, 699 in FIG. 6; 902, 999 in FIG. 9). In aspects, to generate the optimized simulated image frame 1016 (e.g., 650 in FIG. 6; 950 in FIG. 9), the graphics processor 1002 may refrain (e.g., at 970 in FIG. 9) from performing rectification in association with the adjusted (e.g., 912, 914 in FIG. 9) number of GS parameters.

At 1212, the apparatus may output the optimized simulated image frame. For example, referring to FIG. 10, as one example, the graphics processor 1002 may output the optimized simulated image frame 1016 (e.g., 650 in FIG. 6; 950 in FIG. 9). As one example, the graphics processor 1002 may provide the optimized simulated image frame 1016 (e.g., 650 in FIG. 6; 950 in FIG. 9) for a display panel 1003. In aspects, the optimized simulated image frame 1016 (e.g., 650 in FIG. 6; 950 in FIG. 9) may be provided for the display panel 1003 via a display processor 1004 configured to process the optimized simulated image frame 1016 (e.g., 650 in FIG. 6; 950 in FIG. 9) and provide a processed representation 1016′ of the optimized simulated image frame 1016 (e.g., 650 in FIG. 6; 950 in FIG. 9) to the display panel 1003. In some aspects, the display panel 1003 may be, without limitation, a head mounted device (HMD) or the like (e.g., for an application such as a virtual reality (VR) / extended reality (XR) application), a desktop/laptop monitor, a display screen of a wireless communication device, and/or the like. As one example, the graphics processor 1002 may, additionally or alternatively, store the optimized simulated image frame 1016 (e.g., 650 in FIG. 6; 950 in FIG. 9) in a memory, such as a memory associated with the graphics processor 1002 and/or the display processor 1004, as described herein.

In configurations, a method or an apparatus for graphics processing is provided. The apparatus may be a GPU, a CPU, or some other processor that may perform graphics processing. In aspects, the apparatus may be the processing unit 120 within the device 104, or may be some other hardware within the device 104 or another device. The apparatus may include means for generating a simulated image frame based on an input image frame and a first set of Gaussian splat (GS) parameters associated with a GS training model and a first ray tracing operation, means for determining a second set of GS parameters based on the simulated image frame and a loss function, means for generating an optimized simulated image frame based on the simulated image frame, the second set of GS parameters, and a second ray tracing operation, and means for outputting the optimized simulated image frame. The apparatus may further include means for adjusting a number of GS parameters of a set of GS parameters based on the loss function associated with the GS training model to obtain an additional set of GS parameters having an adjusted number of GS parameters, where the loss function is a ray tracing-based loss function. The apparatus may further include means for obtaining the set of GS parameters for the simulated image frame based on the GS training model for the first ray tracing operation. The apparatus may further include means for training the GS training model based on a set of prior simulated image frames, and for generating the loss function based on the trained GS training model.

It is understood that the specific order or hierarchy of blocks/steps in the processes, flowcharts, and/or call flow diagrams disclosed herein is an illustration of example approaches. Based upon design preferences, it is understood that the specific order or hierarchy of the blocks/steps in the processes, flowcharts, and/or call flow diagrams may be rearranged. Further, some blocks/steps may be combined and/or omitted. Other blocks/steps may also be added. The accompanying method claims present elements of the various blocks/steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, where reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects.

Unless specifically stated otherwise, the term “some” refers to one or more and the term “or” may be interpreted as “and/or” where context does not dictate otherwise. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.” Unless stated otherwise, the phrase “a processor” may refer to “any of one or more processors” (e.g., one processor of one or more processors, a number (greater than one) of processors in the one or more processors, or all of the one or more processors) and the phrase “a memory” may refer to “any of one or more memories” (e.g., one memory of one or more memories, a number (greater than one) of memories in the one or more memories, or all of the one or more memories).

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium.

Computer-readable media may include computer data storage media or communication media including any medium that facilitates transfer of a computer program from one place to another. In this manner, computer-readable media generally may correspond to: (1) tangible computer-readable storage media, which is non-transitory; or (2) a communication medium such as a signal or carrier wave. Data storage media may be any available media that can be accessed by one or more computers or one or more processors to retrieve instructions, code, and/or data structures for implementation of the techniques described in this disclosure. By way of example, and not limitation, such computer-readable media may include RAM, ROM, EEPROM, compact disc-read only memory (CD-ROM), or other optical disk storage, magnetic disk storage, or other magnetic storage devices. Disk and disc, as used herein, includes compact disc (CD), laser disc, optical disc, digital versatile disc (DVD), floppy disk, and Blu-ray disc, where disks usually reproduce data magnetically, while discs usually reproduce data optically with lasers. Combinations of the above should also be included within the scope of computer-readable media. A computer program product may include a computer-readable medium.

The techniques of this disclosure may be implemented in a wide variety of devices or apparatuses, including a wireless handset, an integrated circuit (IC) or a set of ICs, e.g., a chip set. Various components, modules or units are described in this disclosure to emphasize functional aspects of devices configured to perform the disclosed techniques, but do not necessarily need realization by different hardware units. Rather, as described above, various units may be combined in any hardware unit or provided by a collection of inter-operative hardware units, including one or more processors as described above, in conjunction with suitable software and/or firmware. Accordingly, the term “processor,” as used herein may refer to any of the foregoing structure or any other structure suitable for implementation of the techniques described herein. Also, the techniques may be fully implemented in one or more circuits or logic elements.

The following aspects are illustrative only and may be combined with other aspects or teachings described herein, without limitation.
Aspect 1 is a method of graphics processing, comprising: generating a simulated image frame based on an input image frame and a first set of Gaussian splat (GS) parameters associated with a GS training model and a first ray tracing operation; determining a second set of GS parameters based on the simulated image frame and a loss function; generating an optimized simulated image frame based on the simulated image frame, the second set of GS parameters, and a second ray tracing operation; and outputting the optimized simulated image frame.
Aspect 2 may be combined with aspect 1, wherein the loss function is a ray tracing-based loss function.
Aspect 3 may be combined with aspect 2, wherein the second set of GS parameters is a subset of GS parameters.
Aspect 4 may be combined with aspect 3, wherein the second set of GS parameters includes at least one less parameter associated with spherical harmonics than the first set of GS parameters.
Aspect 5 may be combined with aspect 2, wherein determining the second set of GS parameters comprises determining the second set of GS parameters further based on a quality improvement determination associated with the simulated image frame and a second number of GS parameters in the second set of GS parameters is greater than a first number of GS parameters in the first set of GS parameters.
Aspect 6 may be combined with any of aspects 1 to 5, further comprising: obtaining an additional set of GS parameters having an adjusted number of GS parameters for the simulated image frame based on the GS training model for the first ray tracing operation.
Aspect 7 may be combined with any of aspects 1 to 6, further comprising: training the GS training model based on a set of prior simulated image frames; and generating the loss function based on the trained GS training model.
Aspect 8 may be combined with aspect 7, wherein the set of prior simulated image frames includes the simulated image frame; or wherein the set of prior simulated image frames is based on a camera simulation.
Aspect 9 may be combined with aspect 8, wherein training the GS training model includes refraining from performing rectification in association with the second set of GS parameters.
Aspect 10 may be combined with aspect 7, wherein training the GS training model includes iteratively adjusting sets of GS parameters for simulated image frames.
Aspect 11 may be combined with any of aspects 1 to 10, wherein at least one of the first set of GS parameters or the second set of GS parameters includes at least one of a set of GS characteristics, a set of per camera GS parameters, a set of per lens GS parameters, or a set of object GS parameters.
Aspect 12 may be combined with aspect 11, wherein at least one of: the set of GS characteristics includes at least one of a position, a location, a covariance, a color, an opacity, or a set of spherical harmonics, the set of per camera GS parameters includes at least one of an exposure setting, an aperture setting, a rolling shutter speed, a motion parameter, a pose parameter, an analog gain, or a digital gain, the set of per lens GS parameters includes at least one of a normal lens parameter, a fisheye lens parameter, a wide-angle lens parameter, or a telephoto lens parameter, or the set of object GS parameters includes at least one of a motion vector or a rotation parameter.
Aspect 13 may be combined with aspect 11, wherein the loss function is based on a weighted function associated with a set of weighting parameters, wherein the set of weighting parameters includes at least one of a reconstruction loss, the set of GS characteristics, the set of per camera GS parameters, or a set of regularization parameters.
Aspect 14 may be combined any of aspects 1 to 13, wherein the input image frame includes a set of raw input image frames, respectively associated with a set of cameras, for an object, wherein the optimized simulated image frame is based on a GS operation associated with the second ray tracing operation and representative of the object in association with the input image frame.
Aspect 15 may be combined with any of aspects 1 to 14, wherein the optimized simulated image frame is based on a first GS operation having a first number of GS parameters based on the GS training model and a second GS operation having a second number of GS parameters based on the GS training model.
Aspect 16 may be combined any of aspects 1 to 15, wherein generating the optimized simulated image frame includes refraining from performing rectification in association with the second set of GS parameters.
Aspect 17 may be combined with any of aspects 1 to 16, wherein generating the simulated image frame includes generating an additional simulated image frame, based on of the input image frame and associated with at least one of motion or a change in time; wherein generating the optimized simulated image frame is also based on the additional simulated image frame, a third set of GS parameters, and a third ray tracing operation, wherein the third set of GS parameters is based on the loss function.
Aspect 18 may be combined with any of aspects 1 to 17, wherein outputting the optimized simulated image frame includes at least one of: storing the optimized simulated image frame in a memory, or providing the optimized simulated image frame for a display panel.
Aspect 19 is an apparatus for graphics processing comprising a processor coupled to a memory and, based on information stored in the memory, the processor is configured to implement a method as in any of aspects 1-18.
Aspect 20 may be combined with aspect 19 and comprises that the apparatus is a wireless communication device.
Aspect 21 is an apparatus for graphics processing comprising means for implementing a method as in any of aspects 1-18.
Aspect 22 is a computer-readable medium (e.g., a non-transitory computer readable-medium) storing computer executable code, the computer executable code, when executed by a processor, causes the processor to implement a method as in any of aspects 1-18.

Various aspects have been described herein. These and other aspects are within the scope of the following claims.

What is claimed is:

1. An apparatus for graphics processing, comprising:
a memory; and
a processor coupled to the memory and, based on information stored in the memory, the processor is configured to:
generate a simulated image frame based on an input image frame and a first set of Gaussian splat (GS) parameters associated with a GS training model and a first ray tracing operation;
determine a second set of GS parameters based on the simulated image frame and a loss function;
generate an optimized simulated image frame based on the simulated image frame, the second set of GS parameters, and a second ray tracing operation; and
output the optimized simulated image frame.

2. The apparatus of claim 1, wherein the loss function is a ray tracing-based loss function.

3. The apparatus of claim 2, wherein the second set of GS parameters is a subset of GS parameters.

4. The apparatus of claim 3, wherein the second set of GS parameters includes at least one less parameter associated with spherical harmonics than the first set of GS parameters.

5. The apparatus of claim 2, wherein to determine the second set of GS parameters, the processor is configured to determine the second set of GS parameters further based on a quality improvement determination associated with the simulated image frame and a second number of GS parameters in the second set of GS parameters is greater than a first number of GS parameters in the first set of GS parameters.

6. The apparatus of claim 1, wherein the processor is further configured to:
train the GS training model based on a set of prior simulated image frames; and
generate the loss function based on the trained GS training model.

7. The apparatus of claim 6, wherein the set of prior simulated image frames includes the simulated image frame; or
wherein the set of prior simulated image frames is based on a camera simulation.

8. The apparatus of claim 7, wherein to train the GS training model, the processor is configured to refrain from performing rectification in association with the second set of GS parameters.

9. The apparatus of claim 6, wherein to train the GS training model, the processor is configured to iteratively adjust sets of GS parameters for simulated image frames.

10. The apparatus of claim 1, wherein at least one of the first set of GS parameters or the second set of GS parameters includes at least one of a set of GS characteristics, a set of per camera GS parameters, a set of per lens GS parameters, or a set of object GS parameters.

11. The apparatus of claim 10, wherein at least one of:
the set of GS characteristics includes at least one of a position, a location, a covariance, a color, an opacity, or a set of spherical harmonics,
the set of per camera GS parameters includes at least one of an exposure setting, an aperture setting, a rolling shutter speed, a motion parameter, a pose parameter, an analog gain, or a digital gain,
the set of per lens GS parameters includes at least one of a normal lens parameter, a fisheye lens parameter, a wide-angle lens parameter, or a telephoto lens parameter, or
the set of object GS parameters includes at least one of a motion vector or a rotation parameter.

12. The apparatus of claim 10, wherein the loss function is based on a weighted function associated with a set of weighting parameters, wherein the set of weighting parameters includes at least one of a reconstruction loss, the set of GS characteristics, the set of per camera GS parameters, or a set of regularization parameters.

13. The apparatus of claim 1, wherein the input image frame includes a set of raw input image frames, respectively associated with a set of cameras, for an object, wherein the optimized simulated image frame is based on a GS operation associated with the second ray tracing operation and representative of the object in association with the input image frame.

14. The apparatus of claim 1, wherein the optimized simulated image frame is based on a first GS operation having a first number of GS parameters based on the GS training model and a second GS operation having a second number of GS parameters based on the GS training model.

15. The apparatus of claim 1, wherein to generate the optimized simulated image frame, the processor is configured to refrain from performing rectification in association with the second set of GS parameters.

16. The apparatus of claim 1, wherein to generate the simulated image frame, the processor is configured to generate an additional simulated image frame, based on the input image frame and associated with at least one of motion or a change in time;
wherein to generate the optimized simulated image frame, the processor is configured to generate the optimized simulated image frame based on the additional simulated image frame, a third set of GS parameters, and a third ray tracing operation, wherein the third set of GS parameters is based on the loss function.

17. The apparatus of claim 1, wherein to output the optimized simulated image frame, the processor is configured to at least one of:
store the optimized simulated image frame in the memory, or
provide the optimized simulated image frame for a display panel; or
wherein the apparatus is a wireless communication device.

18. A method of graphics processing, comprising:
generating a simulated image frame based on an input image frame and a first set of Gaussian splat (GS) parameters associated with a GS training model and a first ray tracing operation;
determining a second set of GS parameters based on the simulated image frame and a loss function;
generating an optimized simulated image frame based on the simulated image frame, a second set of GS parameters, and a second ray tracing operation; and
outputting the optimized simulated image frame.

19. The method of claim 18, wherein the loss function is a ray tracing-based loss function.

20. The method of claim 19, wherein the second set of GS parameters is a subset of GS parameters, such that the second set of GS parameters is less than the first set of GS parameters; or
wherein the method further comprises:
training the GS training model based on a set of prior simulated image frames; and
generating the loss function based on the trained GS training model.
